(19) United States
(12) Patent Application Publication
(10) Pub. No.: US 2024/0212415 A1
(43) Pub. Date: Jun. 27, 2024

(54) Vehicle Vending Machine With Fire Protection System

(71) Applicant: Carvana, LLC, Tempe, AZ (US)

(72) Inventors: Ernest C. GARCIA, III, Phoenix, AZ (US); Bret SASSENBERG, Tempe, AZ (US); Benjamin E. HUSTON, Phoenix, AZ (US)

(21) Appl. No.: 18/536,548

(22) Filed: Dec. 12, 2023

Related U.S. Application Data
(60) Provisional application No. 63/434,485, filed on Dec. 22, 2022.

(51) Int. Cl. G07F 17/00; A62C 3/00; A62C 35/68; E04H 6/28

(52) U.S. Cl. CPC G07F 17/0057; A62C 3/002; A62C 35/68; E04H 6/282

(57) ABSTRACT

Systems, methods, non-transitory processor-readable storage media, and devices of the various embodiments enable a vehicle vending machine to retrieve a customer vehicle from a storage location in a tower and deliver the customer vehicle to a delivery bay. In various embodiments, the vehicle vending machine may further include a fire protection system.

### RELATED APPLICATIONS

This application claims the benefit of priority to U.S. Provisional Patent Application No. 63/434,485 entitled “Vehicle Vending Machine With Fire Protection System” filed on Dec. 22, 2022, the entire contents of which are hereby incorporated by reference for all purposes.

### BACKGROUND

Typically, the provisioning of vehicles to customers is a space-intensive endeavor requiring large surface parking lots. The process of getting vehicles from the outdoor parking lots to the customers is a labor-intensive process requiring a driver to traverse the distance of the surface parking lot, find the desired vehicle, and drive the vehicle to the customer. Historical fire data has shown that vehicle fires in typical parking structures normally fully involve only a single automobile with minor damage to adjacent vehicles. The levels of typical enclosed multi-level parking structures are separated by concrete construction that act as passive fire protection preventing vertical fire spread to cars parked above the level of fire origin.

The levels of vehicles stored in a tower structure of a vehicle vending machine may be separated by solid metal vehicle pallets that shield vehicles from direct flame impingement from a fire originating below. However, there is no full-scale test data or historical fire data that proves that the solid metal vehicle pallet protects vehicles from vertical fire spread in the same manner as concrete slab floor/ceiling construction.

### SUMMARY

The systems, methods, non-transitory processor-readable storage media, and devices of the various embodiments enable a vehicle vending machine to retrieve a vehicle from a storage location and deliver the vehicle to a delivery bay for delivery to a customer. Various embodiments may include a vehicle vending machine including a tower, a robotic carrier, a corridor extending from the tower, and a plurality of delivery bays positioned along the corridor.

Various embodiments may include a vehicle vending machine that includes at least a first delivery bay, a tower with a series of storage locations on different vertically arranged levels, a system configured to retrieve a customer vehicle from a storage location in the tower and deliver the customer vehicle to the first delivery bay, and a fire protection system. In some embodiments, the fire protection system may include a plurality of fire sprinklers, and one or more controller connected to the plurality of fire sprinklers. In some embodiments, the one or more controller is configured to trigger activation of at least an alarm system and an exhaust system. In some embodiments, at least a portion of the series of storage locations may be on at least one of the different vertically arranged levels of the tower that is vertically offset from the first delivery bay.

In some embodiments, the plurality of fire sprinklers may each comprise a thermosensitive sprinkler head and a valve. In some embodiments, water may automatically flow from the valve upon reaching a threshold temperature in surrounding air.

In various embodiments, the alarm system may also include an audible external alarm and an alarm signal that is sent to a supervising station. In some embodiments, the exhaust system may include a plurality of exhaust fans. In various embodiments, the fire protection system may also include a plurality of fire condition detectors connected to the one or more controller, and an emergency vending system connected to the one or more controller. In some embodiments, the one or more controller may be configured to activate the emergency vending system in response to detecting a fire. In various embodiments, the fire condition detectors may be smoke detectors, flame detectors, heat sensors, gas detectors, air sampling system, or any other type detector configured to detect a condition associated with a fire. In some embodiments, the smoke detectors may be addressable smoke detectors. In some embodiments, the air sampling system may be configured to monitor the air within the vehicle vending machine to determine whether particulate within the air is associated with a fire, such as a smoke particulate being above a threshold parts per million in the air of the vehicle vending machine.

In some embodiments, detecting a fire may include identifying a storage location of a vehicle of fire origin based on input from at least one of the plurality of smoke detectors. In some embodiments, activation of the emergency vending system may include triggering delivery of the vehicle of fire origin positioned on a vehicle pallet from the identified storage location in the tower to the first delivery bay.

Various embodiments may include a method for operating a vehicle vending machine with a fire protection system may include detecting a vehicle fire in a storage tower of the vehicle vending machine. Various embodiments may further include activating an alarm system and activating an exhaust system in response to detecting the vehicle fire in the storage tower. In some embodiments, detecting the vehicle fire in a storage tower of the vehicle vending machine may include detecting activation of one or more fire sprinklers positioned within the tower. In some embodiments, activating the alarm system may include activating an audible alarm exterior to the tower within the vehicle vending machine, and automatically sending an alarm signal to a supervising station.

In some embodiments, the exhaust system may include a plurality of fans that are capable of operating simultaneously for a total exhaust volumetric flow rate of at least 16,500 cubic feet per minute (CFM).

In some embodiments, detecting the vehicle fire in a storage tower of the vehicle vending machine may include detecting activation of at least one of a fire sprinkler positioned within the tower and a smoke detector positioned within the tower. Various embodiments may further include identifying a vehicle of fire origin based on the location of at least one of an activated smoke detector or an activated fire sprinkler located within the tower.

Various embodiments may also include activating an emergency vending system for the vehicle of fire origin, and performing a power shutdown of electronic systems of the tower. In some embodiments, activating the emergency vending system for the vehicle of fire origin may include triggering a controller to retrieve the identified vehicle of fire origin positioned on a vehicle pallet from a storage location within the tower. In some embodiments, retrieving the identified vehicle of fire origin positioned on the vehicle pallet may be performed with a lift-able shuttle. Various embodiments may further include delivering the vehicle of fire origin positioned on the vehicle pallet to an appropriate delivery bay of the vehicle vending machine.

In some embodiments, retrieving the identified vehicle of fire origin positioned on the vehicle pallet from the storage location within the tower may include rotating the vehicle pallet from the rotated appropriate orientation, and positioning the vehicle of fire origin positioned on the vehicle pallet onto a robotic carrier.

In some embodiments, activating the exhaust system may include receiving a notification that the vehicle of fire origin positioned on the vehicle pallet has been delivered to the appropriate delivery bay, and automatically opening at least one exterior door of the delivery bay in response to receiving the notification. In some embodiments, the storage location may be vertically offset from a plurality of delivery bays.

Further embodiments include a control system for a vehicle vending machine. Further embodiments include a method of operating a vehicle vending machine. Further embodiments include a non-transitory processor-readable storage medium having stored thereon processor-executable software instructions configured to cause a processor of a vehicle vending machine to perform various operations.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1A is a block diagram of an example of a vehicle vending machine according to various embodiments.

FIG. 1B illustrates an outside view of an example vehicle vending machine according to various embodiments.

FIG. 2A is a block diagram of an example of a vehicle vending machine according to various embodiments.

FIG. 2B illustrates an outside view of an example vehicle vending machine according to various embodiments.

FIG. 2C is a block diagram of a vertically offset upper floor of an example vehicle vending machine according to various embodiments.

FIG. 3A is a block diagram of the underside of an example vehicle turntable according to various embodiments.

FIG. 3B is a block diagram of an example pallet carrier according to various embodiments.

FIG. 3C is a block diagram of an example vehicle turntable according to various embodiments.

FIG. 3D is a block diagram of a portion of the example vehicle turntable of FIG. 3C.

FIGS. 4A-4E are block diagrams of an example of a robotic carrier for use in a vehicle vending machine, according to various embodiments.

FIG. 5 is a block diagram of an example of a pallet carrier for use in a vehicle vending machine, according to various embodiments.

FIGS. 6A-6D are process flow diagrams illustrating examples of methods for operating a vehicle vending machine, according to various embodiments.

FIG. 7 is a process flow diagram illustrating an example of a method for storing a vehicle in a vehicle vending machine, according to various embodiments.

FIG. 8 is process flow diagram illustrating an example of a method for retrieving a vehicle pallet in a vehicle vending machine, according to various embodiments.

FIGS. 9A-9E illustrate movements of a vehicle pallet in a vehicle vending machine according to various embodiments.

FIGS. 10A and 10B are block diagrams illustrating components of a vehicle vending machine robotic carrier system that uses a delivery hitch according to various embodiments.

FIGS. 11A-11D are a block diagrams of example lighting installations for a vehicle vending machine according to various embodiments.

FIG. 11E is a component block diagram of an example lighting system for a vehicle vending machine according to various embodiments.

FIG. 12 is a process flow diagram illustrating an example of a method for controlling a lighting system for a vehicle vending machine, according to various embodiments.

FIGS. 13A-13C are block diagrams of an example fire protection system for a vehicle vending machine according to various embodiments.

FIG. 13D is a block diagram of another example fire protection system for a vehicle vending machine according to various embodiments.

FIGS. 14A-14B are component block diagrams example fire protection systems for a vehicle vending machine according to various embodiments.

FIGS. 15A-15B are process flow diagrams illustrating examples of methods for controlling a fire protection system for a vehicle vending machine, according to various embodiments.

FIG. 16 is a component diagram of an example computing device suitable for use with the various embodiments.

FIG. 17 is a component diagram of another example computing device suitable for use with the various embodiments.

FIG. 18 is a component diagram of an additional example computing device suitable for use with the various embodiments.

FIG. 19 is a component diagram of an example server suitable for use with the various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments provide systems, methods, devices, and non-transitory media for a vehicle vending machine. In various embodiments, the vehicle vending machine may comprise one or more tower, one or more robotic carrier, one or more bay, one or more customer interaction kiosk, and/or one or more video system.

A vehicle vending machine may be utilized to retrieve a vehicle from a storage location and deliver the vehicle to a customer. In various embodiments, the vehicle may be retrieved from a storage location within a tower and placed on a robotic carrier. The robotic carrier may navigate to an appropriate delivery bay and place the vehicle in the delivery bay. A buyer may complete an authentication process and take delivery of the vehicle from the delivery bay.

The discussions of “cars” used herein are for illustrative purposes of example vehicles suitable for use with the various embodiments. Other vehicles, such as trucks, vans, etc., may be substituted in the various embodiments and the term “car” is not intended to limit the various embodiments.

### Loading the Tower.

In various embodiments, the tower may be loaded from a door in the tower itself. The car may be driven from outside the tower onto a ramp that leads up to the tower and through the door at the base of the tower. There may be a hydraulic powered lift gate that bridges the gap between the doorway and a vehicle pallet. This vehicle pallet may be attached to a lift-able shuttle in an atrium at the center of the tower. In some embodiments, the door in the tower itself may be an external door leading outside the vehicle vending machine. In such embodiments, the tower may be directly loaded from the external door. In some embodiments, the door in the tower itself may be a door internal to the vehicle vending machine. In some embodiments, the door in the tower itself may be a tower loading door internal to the vehicle vending machine that may connect to a vehicle preparation area. The vehicle preparation area may be disposed between the tower loading door and an external door of the vehicle vending machine. The vehicle preparation area may be an area in which vehicles may be inspected and prepared prior to loading into the tower. The external door may be opened to enable vehicles to be driven into the vehicle preparation area from outside the vehicle vending machine and/or from the vehicle preparation area out of the vehicle vending machine. The tower loading door may be an automatic door controlled to remain closed while the tower is in operation. Once a vehicle is ready in the vehicle preparation area, the tower loading door may be opened and the vehicle may be driven from the vehicle preparation area through the tower loading door and through a loading area of the tower onto a vehicle pallet. In the loading area of the tower may be a hydraulic powered lift gate that bridges the gap between the tower loading door and a vehicle pallet. This vehicle pallet may be attached to a lift-able shuttle in an atrium at the center of the tower.

Once the vehicle is set in the middle of the pallet, a command may be sent to the tower directing it to lift to the appropriate level. In an embodiment, there may be five levels with four cars each, except for the bottom level which only has two. In other embodiments, less levels or more levels may be used. In some embodiments, there may be no car storage positions at the bottom level. After the pallet is lifted up to the appropriate level, it may be rotated to the correct orientation. The pallet, which may be secured to the arms of the shuttle lift, may be pushed into its assigned position in the tower. Once the pallet is in position, the arms may disengage from the pallet.

In various embodiments, the lifting mechanism may use chains that run up the sides of the tower, as well as a counterbalancing system with weights. Other lifting mechanisms, including hydraulics or gears, may also be used.

### Retrieving a Vehicle From the Tower.

In various embodiments, the process for retrieving a vehicle from the tower may be similar to the system for loading a vehicle into the tower. A command may be sent to the shuttle identifying the storage slot where the desired vehicle is located. The command may be sent from a processor of a control system. The shuttle may be lifted up to the level of the identified storage slot. The shuttle may be rotated to orient itself to be aligned with the storage slot. Arms from the tower may hook onto the desired pallet and then lift the pallet clear of metal pegs which engage the pallet. The pallet may be transposed to be over the shuttle and the pallet may be lowered onto the shuttle. The shuttle may then be lowered to the lowest level, and rotated to orient itself with an entrance to an internal alleyway or corridor. In various embodiments, the internal alleyway or corridor may be a transfer area through which an automatic delivery system transfers the pallet with the vehicle on it to a pick-up bay (also referred to as a delivery bay). In some embodiments, there may be more than one internal alleyway or corridor connected to the tower. For example, there may be two internal alleyways or corridors, more than two internal alleyways or corridors, etc. In a specific embodiment, there may be two internal alleyways or corridors offset by ninety degrees to one another relative to the tower leading to two separate bays with orientations offset ninety degrees to one another. In various embodiments, the corridor may be of any length or shape. For example, the corridor may be forty feet or greater in length, or may be less than forty feet in length, such as only a few feet in length (e.g., the length of a pallet width (such as approximately eight feet in length), less than the length of a pallet width (e.g., one foot in length), etc.). For example, the corridor may have a straight-line shape, curved shape (e.g., a dog-leg left or right), etc. In various embodiments, the corridor may be a portion of the delivery bay itself, such as the portion connecting the delivery bay to the tower.

In some embodiments, an automatic robotic carrier may wait in the alleyway. Once the shuttle is on the lowest level and aligned with the robotic carrier, the pallet may be pushed from the shuttle onto the robotic carrier. Once in place, the arms may disconnect from the pallet. The robotic carrier also may have metal pegs that engage holes in the pallet, securing the pallet in place.

### The Robotic Carrier.

In various embodiments, the robotic carrier may move on wheels. The robotic carrier may include a computer with a pre-programmed model of the alleyway dimensions and the robotic carrier may use lasers to locate reflective tape placed on the walls of the alleyway to determine the robotic carrier's location within the model. The robotic carrier may receive a message directing the robotic carrier to one of the delivery or customer pick-up bays. In an embodiment, there may be three bays, although there may be any number of bays, for example selected depending on size constraints and need. The robotic carrier may operate wheels according to the pre-programmed model and the robotic carrier may monitor a position of the robotic carrier using lasers and the reflective tape to accurately place the robotic carrier within the computerized model (called a “field”), to make sure that the robotic carrier doesn't run into any walls, and to ensure that the robotic carrier makes it to the appropriate bay. The model may also indicate to the robotic carrier when the robotic carrier should turn to enter the designated bay. Once the robotic carrier enters the bay, a lift engages the pallet and lifts the pallet up to a height that's level with the bay's floor, which may be above the elevation of the alleyway floor. Once the pallet is lifted to the level of the bay floor, the pallet may be secured in place. A platform between the back of the vehicle and back doors may rise and lock in place.

### The Pick-Up Bay (Also Referred to as a Delivery Bay).

In various embodiments, after the pallet is secured in the pick-up bay, a signal may be sent to the bay doors that causes the rear doors that lead to the alleyway to close, and allows the front doors to open and customers to enter. In other embodiments, there may be no door (or doors) between the corridor and the pick-up bay. In some embodiments, the customer or employee may inspect the vehicle, and if it is to his or her satisfaction, the customer or an employee may enter the car and drive it out of the bay onto the street and/or other delivery areas outside the vehicle vending machine. In various embodiments, after the pallet is secured in the pick-up bay, a sliding external door of the bay may be unlocked and opened automatically. The bay may include a personnel door separate from the sliding external door. In some embodiments, an employee may open the personnel door and enter the bay via the personnel door. The employee may enter the vehicle on the pallet in the bay and drive the vehicle outside the delivery bay and out of the vehicle vending machine. After the vehicle is driven out of the bay, the sliding external door may close.

### Retrieving the Pallets.

After the vehicle has been removed from the bay, the door may close. Once the door is closed, a command may be sent (e.g., by an interaction of an employee with a control system, automatic door-close signal, etc.) to the robotic carrier, and the robotic carrier may receive a signal indicating that there are no humans or other obstructions in the bay. First the back doors may open and the back platform may lower such that the robotic carrier enters the bay and places itself underneath the pallet. The pallet may be lowered onto the robotic carrier, secured by metal pins on the pallet that engage holes in the pallet. The robotic carrier may then carry the pallet back to the tower, where another vehicle is either loaded onto it, or it is placed in an empty storage slot in the tower.

### The Customer Experience.

In various embodiments, a customer may arrive at a reception area adjacent to the tower alleyway, with a glass window that allows a view into the alleyway. An employee may verify the customer's purchase and may give the customer a coin that is encoded with an RFID device. The customer may then drop the coin into a slot (e.g., a slot of a customer interaction kiosk), which includes a device that detects RFID signals. When the coin passes through the slot device, the RFID device in the coin may be detected and the unique identification may be decoded. A computer system may then look up the unique identification in a database to confirm that it corresponds to a vehicle that was purchased and that is located in the tower. If the vehicle is in the tower, the computer then sends a signal with the position number where the car is located, instructing the tower to retrieve the vehicle in that position and move it to an open bay.

### Alternate Track System.

In various embodiments, the system may use a track or rail system rather than a self-driving robotic carrier. In such embodiments, the robotic carrier may be a carrier that moves along the track or rail system. In such a track or rail embodiment, the carrier may be placed on tracks or rails and may move along the alleyway using the tracks or rails that are secured to the floor. Each bay also may have a pair of tracks or rails that extend perpendicular or nearly perpendicular to the alleyway tracks or rails. There is a junction where the bay tracks or rails and the alleyway tracks or rails meet, which may allow the carrier to either continue down the alleyway tracks or rails or turn to engage the bay tracks or rails, depending on how the junction is configured. Where the last bay and the alley way tracks or rails intersect there may not be a junction but a curved track or rail that diverts the track or rail to connect the end of the alleyway track or rail and the last bay's track or rail.

In various embodiments that use the track or rail system, the carrier may have a separate pallet called a bay pallet. The carrier may carry the bay pallet underneath the pallet on which the car sits, called the tower pallet. The bay pallet engages and secures the tower pallet. Then the carrier carries the bay pallet, tower pallet, and car, until it is aligned with an empty bay. Using a telescoping process, the bay pallet and tower pallet are moved into the bay. The carrier then retracts the telescopic device, leaving the bay pallet, the tower pallet, and the car, in the bay for customer pick-up, and freeing the carrier to go retrieve another bay pallet from another bay and/or to go retrieve another tower pallet and car from the tower. The carrier may also include a rotating system to rotate the bay pallet and tower pallet to orient it with a bay.

### Alternate Linear Delivery System.

In various embodiments, the robotic carrier may be a delivery hitch that may be a linear delivery system driven by a ball screw and guided by two track roller guide rails. This carrier that includes the delivery hitch may connect the tower to the delivery bay through the corridor. In the tower, the vehicles may be placed on top of pallets. The lifting mechanism of the tower may bring the vehicles on the pallet to the ground level. The vehicle and pallet may be transitioned from the turntable of the shuttle to the delivery hitch that may move the vehicle and pallet transversally along the track and roller guides into a selected delivery bay. In such embodiments, more than one carrier may be present in the vehicle vending machine, such as one carrier for each delivery bay. In such embodiments, each carrier may include its own two guide tracks, a delivery hitch, and a driven ball screw. In various embodiments, the delivery hitch may be connected to the guide tracks via four profiled track rollers on a shaft, and two flat track rollers onto the top of the guide track channel. There may be a guide track on two sides of the delivery hitch, and a ball screw that lies on the central axis of this carrier system. The delivery hitch may have six track rollers. Two track rollers may be steel ball bearings with a flat outer bearing contact surface. Four track rollers may be steel ball bearings with a profiled outer bearing contact surface to provide the hitch with lateral stability when paired with a shaft. The drive motor of the ball screw may have a built-in encoder, when paired with the pitch of the ball screw, that may provide constant knowledge of the position of the pallet on the carrier. The range of travel of the delivery hitch may be programmed into the system to prevent over-travel. There may be a proximity switch that detects when a pallet is properly loaded onto the delivery hitch. Once the pallet is positioned onto the delivery hitch, it will depress a spring-loaded steel plate that will position in front of the proximity switch. This switch may then send the “OK” signal to the system to proceed with delivery operations. The floor in the delivery bay may be leveled with the outside floor in a delivery area outside the vehicle vending machine. The corridor connecting the tower to the delivery bay may be prepared with a recess which will allow for the top of the pallet to be flush with the floor of the delivery bay. Additionally, the recessed portion of the delivery bay floor may have a pit that lies along the centerline of the bay which may house the carrier (e.g., house any one or more of the guide tracks, a delivery hitch, driven ball screw, etc.). The corridor may be configured not to be transited by any customers or employees. Once the pallet is correctly placed onto the carrier, a signal may be sent to the control system via a proximity sensor to initiate the remaining sequence to move the pallet into the delivery bay. Once this sequence is initiated, a ball screw drive may deliver the pallet down the corridor into the delivery bay into a “final position” which may be indicated by an embedded encoder inside of the ball screw drive motor. After the vehicle is driven off the pallet out of the delivery bay, a delivery bay sliding door may close and the carrier may reverse the delivery process to return the empty pallet to the tower through the corridor.

### Automatic Video System.

In various embodiments, cameras may be placed at important vantage points in the tower, including at the following locations: (1) on the ceiling of the tower looking downward to capture a birds-eye view of the tower; (2) from within each storage slot in the tower looking at the side of the vehicle; (3) at the base of the tower, adjacent to the passage from the tower atrium to the alleyway, and looking across that passage; (4) from the far end of the alleyway, looking down the alleyway toward the passage to the tower; (5) from the portion of the pick-up bay closest to the street, looking back toward the passage from the pick-up bay to the alleyway; and/or (6) from within the pick-up bay, looking toward the portion closest to the street where customers will be looking on.

In various embodiments, these cameras may be constantly recording video and may be synchronized to a same clock. When a vehicle retrieval command is issued to the tower, the computer system may record timestamps of key events in the vehicle's retrieval, including: (1) when the vehicle is stationary in the storage slot; (2) when the vehicle is picked up by the tower shuttle; (3) when the vehicle is descending down the tower shuttle; (4) when the vehicle is placed on the robotic carrier; (5) when the vehicle is carried down the alley way by the robotic carrier; (6) when the vehicle enters the pick-up bay; and/or (7) when the doors to the entrance of the pick-up bay open to allow the customer to enter.

In various embodiments, the computer system may automatically retrieve the videos recording from specific cameras of specific times during their recording based on the timestamps recording corresponding to the vehicle's retrieval. For example, the computer system retrieves video from the aerial view of the tower from when the vehicle pallet first enters the tower atrium until its descent is complete.

In various embodiments, the computer system may then join these video segments together into one video, and optionally add a template introduction or conclusion to the video. The video may be stored on a server, and a link may be sent to the customer which allows a customer to download the video or share it on one of multiple social media sites, such as Facebook or YouTube.

### Lighting System.

In various embodiments, a vehicle vending machine may include a lighting system. The lighting system may include one or more various types of lighting fixtures (also referred to as light fixtures or lights) installed in one or more locations within the vehicle vending machine, such as in a vehicle preparation area, in a tower, in a loading area, in a storage location, in a delivery bay, etc. In various embodiments, lighting fixtures within the vehicle vending machines may include incandescent type lighting fixtures, light emitting diode (LED) (e.g., organic LEDs (OLEDs), high power LED (HP LEDs), etc.) type lighting fixtures, and/or any other type lighting fixtures. In various embodiments, lighting fixtures may be fixed position lights, such as strip lights, light bars, fixed spot lights, or any other type light that may not change focal direction after installation, and/or moveable position lights, such as controllable spot lights, rotating lights, or any other type light including a controllable actuator (e.g., a motor, etc.) configured to change the focal direction of the light after installation. In various embodiments, one or more lighting fixture of the lighting system may be configured to change light color and/or light intensity output. For example, the light fixtures may be adjustable LED type lights configured to output different light colors and/or different light intensities in response to lighting control commands. In various embodiments, one or more lighting fixture of the lighting system may be configured to change light output focus, such as from a flood pattern to a focused spot pattern, etc. In various embodiments, the one or more lighting fixtures may be connected to a power system of the vehicle vending machine.

In various embodiments, the one or more lighting fixtures may be connected to a control system of the vehicle vending machine. For example, the lighting fixtures may be connected via wired and/or wireless connections with one another and/or one or more processors of the control system of the vehicle vending machine. In various embodiments, one or more processors of the control system of the vehicle vending machine may be configured to control the operation of the one or more lighting fixtures to illuminate features of the vehicle vending machine and/or vehicles within the vehicle vending machine. In various embodiments, the connected lighting fixtures of the lighting system of the vehicle vending machine may form a lighting network and the one or more processors may control individual lighting fixtures and/or two or more lighting fixtures together to illuminate features of the vehicle vending machine and/or vehicles within the vehicle vending machine. As examples, one or more lighting fixtures may be turned on and/or off, one or more lighting fixtures may be controlled to change output light color, one or more lighting fixtures may be controlled to produce a different lighting pattern (e.g., all lights in a light bar on, some lights in a light bar on, lights in a light bar blinking, etc.), one or more lighting fixtures may be controlled to adjust an intensity of the output light (e.g., made brighter, made dimmer, etc.), one or more lighting fixtures that are moveable (e.g., moveable spot lights, etc.) may be controlled to change focal direction (e.g., rotated, elevated, etc.), one or more lighting fixtures may be controlled to adjust the focus of an output beam (e.g., adjusted from a focused spot output to a wide flood output), and/or one or more lighting fixtures may be controlled in any other manner. In various embodiments, the control of the lighting system of the vehicle vending machine may be coordinated with the control of the video system of the vehicle vending machine.

In various embodiments, the control system of the vehicle vending machine may control the lighting system to change the lighting output configurations of the various light fixtures of the lighting system in response to different events occurring in the vehicle vending machine. For example, a first lighting configuration may be associated with a vehicle being delivered from a vehicle preparation area to a loading area, a different, second lighting configuration, may be associated with a vehicle being lifted within the tower to a storage location, and still different, third lighting configuration may be associated with the delivery of a vehicle from a storage location in the tower to a delivery bay. In various embodiments, the control of the various lighting fixtures of the lighting system may improve the customer experience in delivering a customer's selected vehicle from a storage location in the tower to a delivery bay.

### Fire Protection System.

In various embodiments, a vehicle vending machine may include a fire protection system. The fire protection system may have an automatic sprinkler system with sprinklers installed in one or more locations within the vehicle vending machine, such as in a vehicle preparation area, in a tower, in a loading area, in a storage location, in a delivery bay, etc.

In various embodiments, the automatic sprinkler system may include quick-response or standard-response fire sprinklers. The fire sprinklers in various embodiments may include various types of thermosensitive sprinkler heads (e.g., pendent, upright, or sidewall). The fire sprinklers may be configured to achieve a particular K-factor depending on building/fire codes. For example, the automatic sprinkler system may include 5.6K fire sprinklers with a ½″ (12.7 mm) thread connection and/or 8.0K fire sprinklers with a ¾″ (19.1 mm) thread connection.

In various embodiments, the thermosensitive sprinklers may be automatic sprinkler heads with a trigger mechanism using a fusible metal link or a glass bulb. For example, a glass bulb may be filled with a glycerin-based liquid that expands in response to surrounding air reaching a particular temperature, resulting in the glass breaking. In some embodiments, (i.e., wet sprinkler systems) the pressurized water in the sprinkler pipes may force a plug out and spray over a deflector plate that disperses it in a uniform pattern. In such wet sprinkler systems, the water may continue to flow until the main valve is shut or the supply runs out. In other embodiments (i.e., dry sprinkler systems), activation of the sprinkler head may cause the air pressure in the pipes to drop, opening a dry pipe valve near the system riser that holds back water. Water may flood the pipes and disperse through the open sprinklers.

In another example, a fusible link made up of two metal plates held together by solder may be present instead of the glass bulb and liquid. When the area around the sprinkler head reaches a certain temperature, the solder melts and two spring arms may pull the plates apart. Such action may trigger a plug to fall away and release of the water being held back.

In embodiment vehicle vending machines, the top floor of a storage tower may include a set of sprinklers located above the lift-able shuttle, as well as sprinklers positioned directly above each vehicle storage location of that tier. For example, four sprinklers may be installed on the upper inside roof in the tower. In some embodiments, a set of four or two overhead sprinklers may be positioned above each of vehicle storage locations.

In various embodiments, each intermediate floor of the tower (i.e., on a different vertical level than the ground floor and below the top floor) may include a set of two or four in-rack sprinklers to protect each vehicle storage location. In particular, the in-rack sprinklers for each vehicle storage location may be housed on the bottom of the pallet for the vehicle storage location directly above.

In some embodiments, each vehicle stored in an intermediate floor of the tower may be protected by four in-rack or overhead sprinklers configured to discharge 30 gallons per minute (gpm) for an effective sprinkler density of 0.5 gpm per square foot. In some embodiments, each vehicle stored in an intermediate floor of the tower may be protected by two in-rack or overhead sprinklers discharging 30 gpm, with an effective sprinkler density of 0.375 gpm per square foot over 1415 square feet. In various embodiments, the tower may be configured with mechanical ventilation for the purposes of climate control and air circulation.

Such ventilation may be provided by two exhaust fans, which may be located at the tower's roof and directly discharging to atmosphere. In some embodiments, a first exhaust fan may be a Greenheck GB-360-15 belt driven unit that has an airflow of 12,000 cubic feet per minute (CFM). In some embodiments, a second exhaust fan may be a Greenheck GB-300-10 belt driven unit that has an airflow of 4,500 CFM. In some embodiments, each exhaust fan may include a manually operated two-speed switch (for example, located in the tower or outside the tower as directed by the local fire department).

In various embodiments, when a fire is detected in the tower both exhaust fans may operate simultaneously for a total exhaust volumetric flow rate of 16,500 CFM (5.6 air changes per hour). This volumetric flow rate in concert with the fire sprinkler system may maintain the smoke layer to an elevation equal to or above the pallet of a vehicle of fire origin.

At the base of the tower, there may be two delivery bays with large doors that may be used for loading and unloading cars from the tower. These doors may be opened automatically to provide makeup air for the exhaust, such as in an event of a fire. Further, the window of the vehicle on fire may also be knocked out in order to allow for a more efficient firefighting. Moreover, the exhaust fans may be used by firefighters as a post-fire smoke purge system.

In various embodiments, the tower portion of the vehicle vending building may be on a separate sprinkler zone/riser feed from the remainder of the vehicle vending machine. In some embodiments, the fire sprinkler system waterflow alarm devices and supervisory devices may be electronically supervised and monitored by an approved supervising station. Additionally, a minimum outside hose stream of 250 gpm may be provided.

Therefore, the tower in the various embodiments may be sprinklered with a custom design intended to address the specific hazard presented by the tower. This design may be an overall combination of active and passive protection strategies that is prudent for this unoccupied specialized structure that temporarily stores vehicles with internal combustion engines, electric-drive vehicles, and/or hybrid electric vehicles.

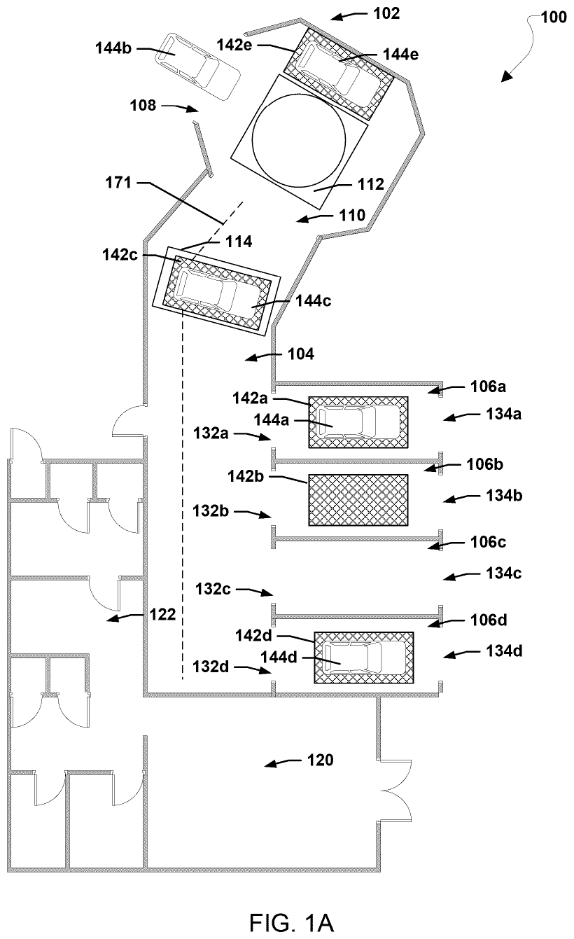

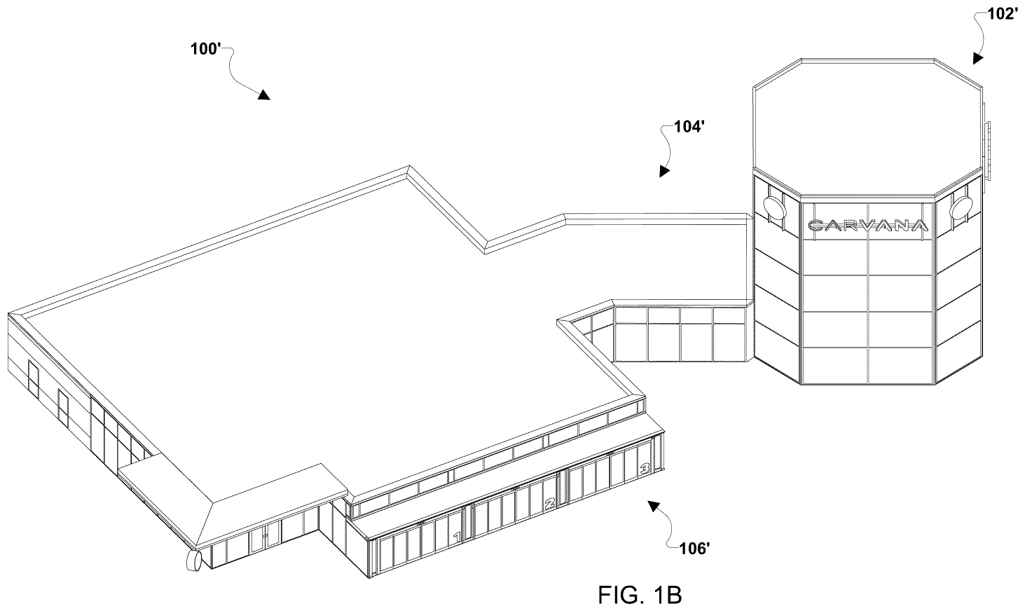

FIG. 1A illustrates an example of a vehicle vending machine 100 according to various embodiments. Vehicle vending machine 100 may include a tower 102, a corridor 104, and a plurality of delivery bays 106a-106d. The tower 102 may include an exterior door 108 and an opening 110 positioned between the tower 102 and the corridor 104. The tower 102 may also include a lift-able shuttle 112 located within the center of the tower 102. Vehicle vending machine 100 may also include a lobby 120 and offices 122. One or more processors may be connected to the various motors, sensors, displays, cameras, and other equipment described herein that may be used in the vehicle vending machine to control such equipment to perform the operations described herein. The tower 102 may provide for the storage and display of vehicles on the different levels of the tower 102, such as 4 vehicles per level. The tower 102 may include multiple levels, such as 5 to 8, or more than 8 levels. The tower 102 may be a metallic structure with foundation and roof, vehicle pallets, and a central pick up lift-able shuttle 112. The lift-able shuttle 112 combines the functionalities of lifting, turning and moving of the platforms. The lift-able shuttle 112 may be located in the center of the tower 102 structure among the 4 main stays and has lifting and rotating movements. The vertical movement of the lift-able shuttle 112 may be driven by motors (e.g., 4 motors) integrated into the main columns directly under the roof and counterweights of the lifting system.

In various embodiments, each delivery bay 106a-106d may include an interior door 132a-132d positioned between the delivery bay and the corridor 104 as well as an exterior door 134a-134d positioned between the delivery bay and an exterior of the vehicle vending machine 100. In some embodiments, each interior door 132a-132d may only be opened when the corresponding exterior door 134a-134d is closed and each exterior door 134a-134d may only be opened when the corresponding interior door 132a-132d is closed.

Various vehicles 144a-144e and various vehicle pallets 142a-142e are illustrated in FIG. 1A. In various embodiments, vehicles 144a-144e are positioned on vehicle pallets 142a-142e within the vehicle vending machine 100. For example, FIG. 1A illustrates robotic carrier 114 carrying vehicle 144c positioned on vehicle pallet 142c. In various embodiments, the vehicle pallets 142a-142e may be closed metallic structures. The surfaces of the pallets 142a-142e may have an anti-skid coating. The pallets may be fitted with any type vehicle. A slight elevation in the middle of the pallets 142a-142e may act as a wheel deflector for positioning the car better. Wheels may ensure the sliding of the pallet and eyelets may be the hooking points for a pallet carrier.

In one embodiment, robotic carrier 114 may navigate corridor 104 while carrying vehicle 144c positioned on vehicle pallet 142c. The robotic carrier 114 may operate as an automated delivery system (ADS) to deliver vehicles from the tower 102 to the bays 106a-d. In this embodiment, robotic carrier 114 may deliver vehicle 144c positioned on vehicle pallet 142c to delivery bay 106c for delivery to a customer. In some embodiments, the robotic carrier 114 may traverse the corridor 104 independently by driving down the corridor 104 and aligning itself using its wheels within the corridor 104. In other embodiments, an optional track 171 or rail system may be included in the corridor 104 to guide the robotic carrier 114 through the corridor 104. The robotic carrier 114 may use a conductor line system for the transmission of power and data. A contact line may be installed in the floor of the corridor 104 to indicate that bays 106a-d and that will supply the robotic carrier 114 with electric power. On the same line data for the robotic carrier 114 to transport the pallets to the necessary bays. May be provided. The position of the robotic carrier 114 may be continuously monitored by a laser sensor placed underneath the robotic carrier 114. This laser sensor may read head moves along a bar code tape and the processor may calculate the absolute position data in the direction of travel with millimeter accuracy. This accuracy is possible because the laser scans simultaneously 3 bar codes and has flexible read distances which makes possible to bridge mechanical deviations. The labeling system allows the robotic carrier 114 to continue operation after an interruption (e.g., voltage drop or emergency stop) without needing to use a reference point. The communication with the robotic carrier 114 may be via wireless or wired communication, such as via WLAN (e.g., Wi-Fi, etc.) to a WLAN access point on the robotic carrier 114.

As shown in FIG. 1A, vehicle 144a positioned on vehicle pallet 142a may be located in delivery bay 106a for delivery to a customer and vehicle 144d positioned on vehicle pallet 142d may be located in delivery bay 106d for delivery to another customer. In addition, vehicle 144e positioned on vehicle pallet 142e may be located in a storage slot of the tower 102. In various embodiments, robotic carrier 114 may be configured to retrieve an empty pallet, such as vehicle pallet 142b, from a delivery bay, such as delivery bay 106b, and return the empty pallet to the tower 102. In various embodiments, a customer may decline or otherwise decide not to take delivery of a vehicle, in which case the robotic carrier 114 may be configured to retrieve the vehicle positioned on a vehicle pallet from the delivery bay (e.g., vehicle 144d positioned on vehicle pallet 142d in delivery bay 106d).

FIG. 1B illustrates an outside view of an example vehicle vending machine 100′ according to various embodiments. Vehicle vending machine 100′ may be similar to vehicle vending machine 100 described above and below; and in a similar manner vehicle vending machine 100′ may also include a tower 102′, a corridor 104′, and a plurality of delivery bays 106′ as well as other devices and systems described herein.

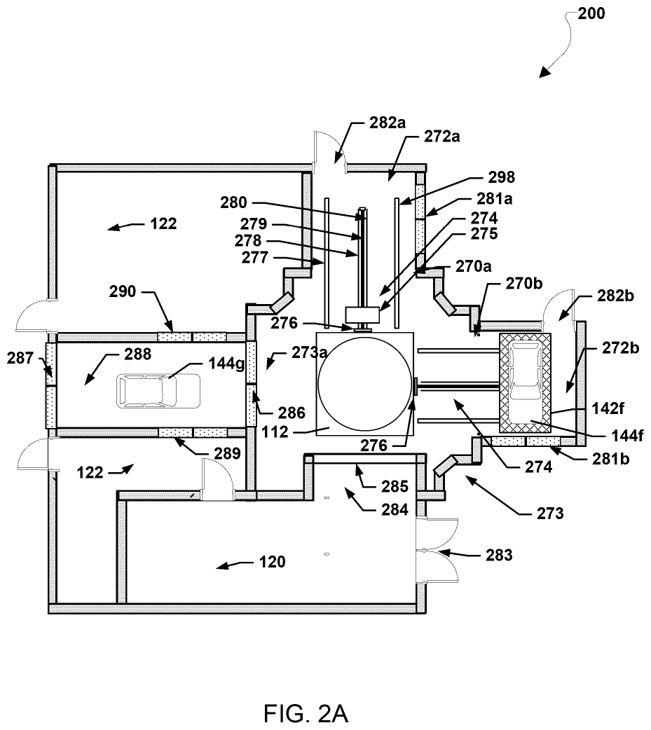

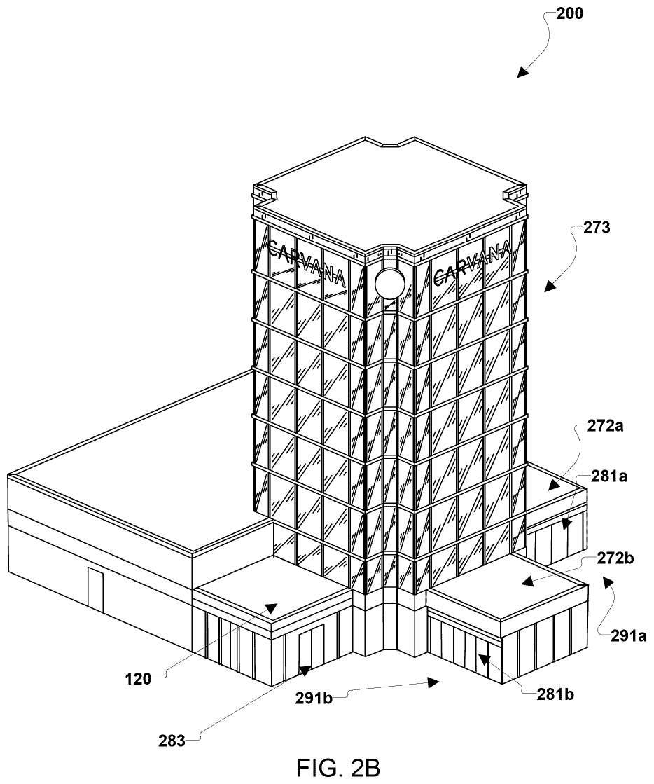

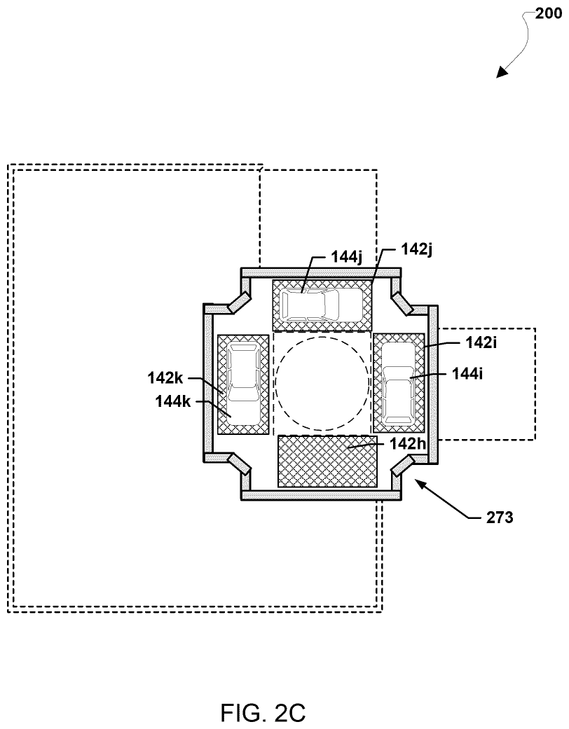

FIG. 2A illustrates an example of a vehicle vending machine 200 according to various embodiments. FIG. 2A is a ground floor cut-away view of the vehicle vending machine 200 illustrating the inside of the vehicle vending machine 200. FIG. 2B illustrates an outside view of the vehicle vending machine 200. FIG. 2C is an upper floor cut-away view of inside of the vehicle vending machine 200, specifically showing storage locations in the tower 273 of the vehicle vending machine that are on a different vertical level than the ground floor illustrated in FIG. 2A.

With reference to FIGS. 1-2C, the vehicle vending machine 200 may be similar to vehicle vending machines 100 and 100′ described above and below and may include many of the same devices and systems described therein. Vehicle vending machine 200 may differ from vehicle vending machines 100 and 100′ in that the vehicle vending machine 200 may include a corridor 270a and 270b associated with each delivery bay 272a and 272b such that, in vehicle vending machine 200, a vehicle may laterally traverse from the tower 273 to the delivery bay 272a or 272b. In various embodiments, the vehicle vending machine 200 may be configured such that the vehicles from the tower 273 transit from the tower 273 into a selected delivery bay 272a or 272b along a direction perpendicular to the forward driving direction of the vehicle. Put another way, the vehicle vending machine 200 may be configured to deliver the vehicles from the tower 273 sideways into a selected delivery bay 272a or 272b.

The vehicle vending machine 200 may include a tower 273, a plurality of delivery bays 272a-272b, and a plurality of corridors 270a-270b, each corridor 270a-270b connecting a respective one of the delivery bays 272a-272b to the tower 273. In various embodiments, the delivery bays 272a and 272b may be offset ninety degrees to one another relative to the tower 273 and lift-able shuttle 112. The lift-able shuttle 112 may be at the center of the tower 273. The vehicle vending machine 200 may include a lobby 120 and office 122 or other type areas, such as work areas, restrooms, machinery spaces, etc. One or more processors may be connected to the various motors, sensors, displays, cameras, and other equipment described herein that may be used in the vehicle vending machine 200 to control such equipment to perform the operations described herein. The tower 273 may provide for the storage and display of vehicles on the different levels of the tower 102, such as 4 vehicles per level. For example, FIG. 2C illustrates an upper level of the tower 273 that may be disposed vertically over the ground floor level of the tower 273 and overall vehicle vending machine 200 shown in FIG. 2A. The tower 273 may include multiple levels, such as 2 or more levels, such as 5 to 8 levels, or more than 8 levels. The upper level of the tower 273 illustrated in FIG. 2C may represent any of the upper levels of the tower 273 vertically arranged over the ground floor of the tower 273, such as the second, third, fourth, fifth, sixth, seventh, eighth, etc., levels. The tower 273 may be a metallic structure with foundation and roof, vehicle pallets, and a central pick up lift-able shuttle 112. The lift-able shuttle 112 combines the functionalities of lifting, turning and moving of the platforms. The lift-able shuttle 112 may be located in the center of the tower 273 structure among the 4 main stays and has lifting and rotating movements. The vertical movement of the lift-able shuttle 112 may be driven by motors (e.g., 4 motors) integrated into the main columns directly under the roof and counterweights of the lifting system.

In various embodiments, each delivery bay 272a-272b may be open to its respective corridor 270a-270b that connects to the tower 273. Each delivery bay 272a-272b may include an exterior door 281a-281b, respectively, that may be positioned between the delivery bay 272a-272b and an exterior of the vehicle vending machine 200. The delivery bay exterior doors 281a-281b may be configured to enable a vehicle to be driven from the delivery bay 272a-272b out of the vehicle vending machine 200 for delivery to a customer. Additionally, each delivery bay 272a-272b may include a personnel door 282a-282b, respectively, that may enable an employee to enter the respective delivery bay 272a-272b to drive a vehicle out of the delivery bay 272a-272b and vehicle vending machine 200 for delivery to a customer. In some embodiments, each delivery bay exterior doors 281a-281b and/or each personnel door 282a-282b may only be opened when a vehicle on a pallet has been delivered to the respective delivery bay 272a-272b. In various embodiments, after a pallet is secured in the respective delivery bay 272a-272b, the respective delivery bay exterior door 281a-281b (e.g., a sliding door) may be unlocked and opened automatically.

In various embodiments, a control system of the vehicle vending machine 200 may control the locking/unlocking and/or opening/closing of the delivery bay exterior doors 281a-281b and personnel doors 282a-282b. The control system may communicate the status of the delivery bay exterior doors 281a-281b and personnel doors 282a-282b to an employee via one or more control panel, such as a portable computing device used by the employee. The control panel may have a unique identifier, such as a service set identifier (SSID), that may be monitored by wireless by the control system of the vehicle vending machine 200 to enable opening or closing of the delivery bay exterior doors 281a-281b and/or personnel doors 282a-282b. Additionally, the control panel may enable an employee to open or close and/or lock or unlock the delivery bay exterior doors 281a-281b and/or personnel doors 282a-282b.

In various embodiments, a carrier, such as an automatic delivery system (ADS) 274, may be arranged in the corridors 270a-270b and delivery bays 272a-272b. Each corridor 270a-270b and delivery bay 272a-272b pair may have its own respective ADS 274. The ADS 274 may be a robotic carrier configured to traverse a vehicle on a pallet (or an empty pallet) from the lift-able shuttle 112 in the tower 273 through a respective corridor 270a-270b and into a respective delivery bay 272a-272b, as well as traverse empty pallets (or pallets with vehicles on them) from a respective delivery bay 272a-272b through a respective corridor 270a-270b and onto the lift-able shuttle 112 in the tower 273. The ADS 274, a type of robotic carrier, may include a delivery hitch 275 that may be a linear delivery system driven by a ball screw 279 and guided by two track roller guide rails 278 and 280. The delivery hitch 275 may be connected to the guide tracks 278, 280 via four profiled track rollers on a shaft, and two flat track rollers onto the top of the guide track channel. There may be a guide track 278, 280 on two sides of the delivery hitch 275, and a ball screw 279 that lies on the central axis of this carrier system. The delivery hitch 275 may have six track rollers. Two track rollers may be steel ball bearings with a flat outer bearing contact surface. Four track rollers may be steel ball bearings with a profiled outer bearing contact surface to provide the hitch 275 with lateral stability when paired with a shaft. The drive motor 276 of the ball screw 279 may have a built-in encoder, when paired with the pitch of the ball screw 279, that may provide constant knowledge of the position of the pallet on the carrier. The range of travel of the delivery hitch 275 may be programmed into the system to prevent over-travel. There may be a proximity switch that detects when a pallet is properly loaded onto the delivery hitch 275. Once the pallet is positioned onto the delivery hitch 275, it will depress a spring-loaded steel plate that will position in front of the proximity switch. This switch may then send the “OK” signal to the system to proceed with delivery operations.

In various embodiments, the floor in a delivery bay 272a-272b may be leveled with the outside floor in a delivery area outside the vehicle vending machine 200, such as a delivery area 291a-291b, respectively, outside the exterior doors 281a-281b of the delivery bays 272a-272b. The corridors 270a-270b connecting the tower 273 to the delivery bays 272a-272b, respectively, may be prepared with a recess which will allow for the top of the pallet to be flush with the floor of the delivery bays 272a-272b. Additionally, the recessed portion of the delivery bays 272a-272b floors may have a pit that lies along the centerline of the bays 272a-272b which may house portions of the robotic carrier (e.g., ADS 274 and its associated equipment). The corridors 270a-270b may be configured not to be transited by any customers or employees. Once the pallet is correctly placed onto the carrier (e.g., on delivery hitch 275), a signal may be sent to the control system via a proximity sensor to initiate the remaining sequence to move the pallet into the respective delivery bay 272a-272b. Once this sequence is initiated, the ball screw drive 279 may deliver the pallet down the corridor into the respective delivery bay 272a-272b into a “final position” which may be indicated by an embedded encoder inside of the ball screw drive motor 276. After the vehicle is driven off the pallet out of the respective delivery bay 272a-272b, the respective delivery bay exterior door 281a-281b (e.g., a sliding door) may close and the ADS 274 may reverse the delivery process to return the empty pallet to the tower 273 through the respective corridor 270a-270b. In some embodiments, the pallet may be empty because the vehicle was driven out of the delivery bay exterior door 281a, 281b to show to a customer. The delivery bay exterior door 281a, 281b may close after the vehicle exits the delivery bay 272a, 272b, thereby preventing the vehicle from being returned to the pallet. Should the customer accept delivery of the vehicle, the vehicle may be possessed by the customer. Should the customer decline delivery of the vehicle, the vehicle may be driven by the employee around the vehicle vending machine 200 to the exterior door 287 for return to the tower 273 through the vehicle preparation area 288 and tower loading door 286. In this manner, vehicles may not be reloaded onto pallets in the respective delivery bays 272a, 272b.

In some embodiments, the vehicle vending machine 200 may include a tower loading door 286 internal to the vehicle vending machine 200 that may connect to a vehicle preparation area 288. The vehicle preparation area 288 may be disposed between the tower loading door 286 and an external door 287 of the vehicle vending machine 200. The vehicle preparation area 288 may be an area in which vehicles may be inspected and prepared prior to loading into the tower 273. The external door 287 may be opened to enable vehicles to be driven into the vehicle preparation area 288 from outside the vehicle vending machine 200 and/or from the vehicle preparation area 288 out of the vehicle vending machine 200. The vehicle preparation area 288 may include doors that do not lead to the tower 273 as well, such as doors 289-290 that may enable employees to enter/exit the vehicle preparation area 288 from/to the offices 122, lobby 120, and or other internal spaces of the vehicle vending machine 200 other than the tower 273. The tower loading door 286 may be an automatic door controlled to remain closed while the tower 273 is in operation. Once a vehicle is ready in the vehicle preparation area 288, the tower loading door 286 may be opened and the vehicle may be driven from the vehicle preparation area 288 through the tower loading door 286 and through a loading area 273a of the tower 273 onto a vehicle pallet on the lift-able shuttle 112. In the loading area 273a of the tower 273 may be a hydraulic powered lift gate that bridges the gap between the tower loading door 286 and a vehicle pallet. This vehicle pallet may be attached to the lift-able shuttle 112 in an atrium at the center of the tower 273.

The vehicle vending machine 200 may also include a customer viewing area 284 connected to the lobby 120 that may include a glass wall 285 (or otherwise transparent wall, such as a windowed wall, etc.) that provides a view of the operations of the tower 273. The customer viewing area 284 may not allow customers access to the tower 273 machinery. The customer viewing area 284 may include various additional elements, such as a customer interaction kiosk, a virtual reality station, cameras, lights, etc.

In FIGS. 2A-2C, various vehicles 144f, 144g, 144i, 144j, and 144k are shown in various places throughout the vehicle vending machine 200. For example, FIG. 2A illustrates vehicle 144g in the vehicle preparation area 288 and vehicle 144f on a vehicle pallet 142f delivered by the ADS 274 from the lift-able shuttle 112 of the tower 273 through the corridor 270b and into a final position in delivery bay 272b. Additionally, vehicles 144i, 144j, and 144k are shown on vehicle pallets 142i, 142j, and 142k in FIG. 2C stowed in stowage locations in the upper level of the tower 273. Additionally, empty vehicle pallet 142h is shown stowed in the upper level of the tower 273. In the tower 273, the vehicles may be placed on top of pallets. The lifting mechanism of the tower 273 may bring the vehicles on the pallet to the ground level. The vehicle and pallet may be automatically transitioned from the turntable of the shuttle 112 to delivery hitch 275 by the shuttle 112 itself, and the delivery hitch 275 and ball screw 279 may move the vehicle and pallet transversally along the tracks and roller guides (e.g., 277, 278, 280, 298) into a selected delivery bay 272a-272b. The vehicle pallets 142f, 142h, 142i, 142j, and 142k are similar to vehicle pallets previously discussed herein, such as vehicle pallets 142a-144e and may be closed metallic structures with an anti-skid coating surface. The pallets may be fitted with any type vehicle. A slight elevation in the middle of the pallets may act as a wheel deflector for positioning the vehicle better. Wheels on the underside of the pallet may ensure the sliding of the pallet and eyelets may be the hooking points for a pallet carrier. For example, wheels on the underside of the vehicle pallets may be arranged perpendicular to the storage direction of a vehicle on the pallet and may slide along rails or tracks in the lift-able shuttle 112, rails or tracks in the storage locations in the tower 273, and/or rails or tracks in the corridors 270a-270b and delivery bays 272a-272b (such as rails or tracks 277 and 298) to enable to pallets to be moved laterally throughout the tower 273, the corridors 270a-270b, and/or the delivery bays 272a-272b. As such, vehicles on vehicle pallets may move laterally (i.e., side-to-side) in the vehicle vending machine 200 relative to the normal forward/reverse driving direction of the vehicles that the vehicles may move when entering/exiting the vehicle vending machine 200 (e.g., through external door 287), driving onto/off of the lift-able shuttle 112 (i.e., to be placed on or removed from a pallet on the shuttle 112), or driving out of the deliver bays 272a-272b through the external bay doors 281a-281b. In various embodiments, a customer may decline or otherwise decide not to take delivery of a vehicle, in which case the ADS 274 may be configured to retrieve the vehicle positioned on a vehicle pallet from the appropriate delivery bay 272a-272b and return it to the tower 273 and lift-able shuttle 112.

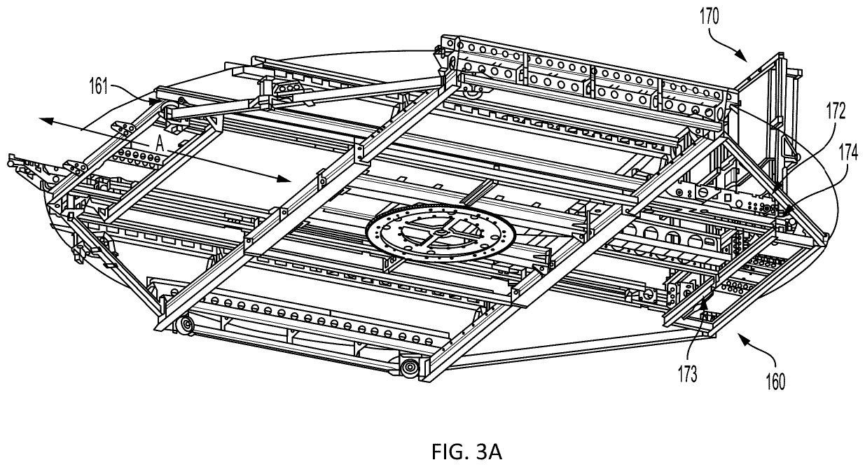

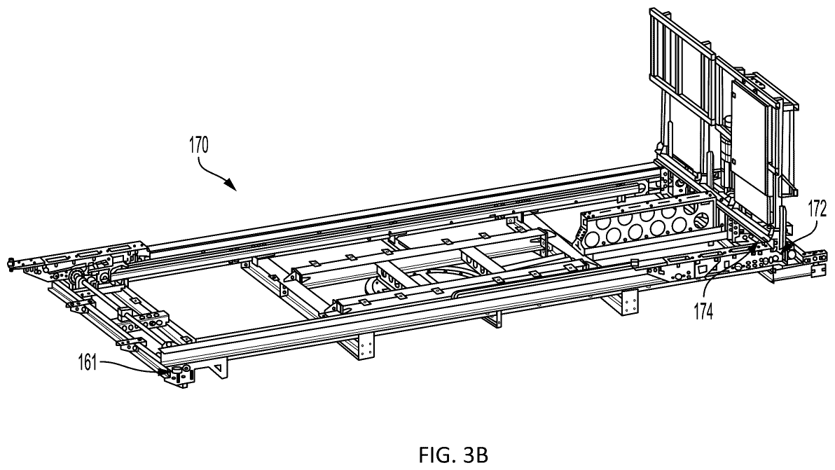

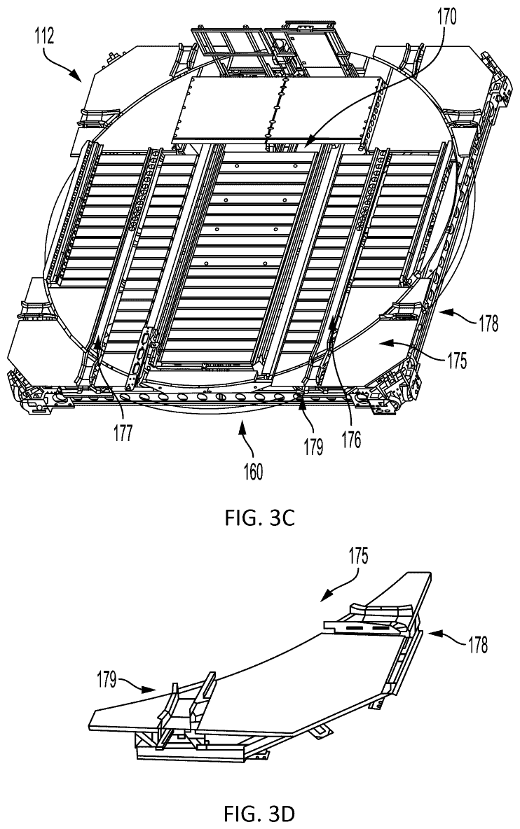

FIG. 3A illustrates the underside of an example vehicle turntable 160 according to various embodiments. The turntable 160 may be a portion of the lift-able shuttle 112 within the tower (e.g., tower 102, 102′, 273, etc.). As a vehicle, such as vehicle is driven onto the lift-able shuttle 112, the turntable 160 may enable the vehicle and its vehicle pallet to be rotated to align with the storage areas in the tower (e.g., tower 102, 102′, 273, etc.). The pallet carrier 170 may be a portion of the turntable 160 and may support the vehicle pallet on the lift-able shuttle 112 and turntable 160. The turntable 160 may provide stability and guides the shuttle 112 up and down the mainstays while the pallet-carrier 170 that telescopes may pick up the car pallets from their parking position. FIG. 3B illustrates the pallet carrier 170 in more detail. The pallet carrier 170 and turntable 160 may rotate together around a central axis to align vehicles and their vehicle pallets for storage in the tower (e.g., tower 102, 102′, 273, etc.), retrieval from the tower, and placement on a carrier (e.g., carrier 114, ADS 274, etc.). The pallet carrier 170 may extend in direction “A” out from and into the turntable 160 to move vehicle pallets onto and off of the lift-able shuttle 112. FIG. 3C illustrates the top of the fully assembled lift-able shuttle 112 showing the pallet carrier 170 within the turntable 160 with corner guides 175 installed. FIG. 3D illustrates a close up view of one corner guide 175. The turntable 160 may rotate to align rails or tracks 176 and 177 with rails or tracks 178 or 179 in the corner guides 175. The rails or tracks 176, 177, 178, and 179 may be configured to receive the wheels on the underside of the vehicle pallets and when aligned, those wheels may allow the vehicle pallet to be guided down the rails or tracks 176, 177, 178, and 179 onto and/or off of the lift-able shuttle 112. The rails or tracks 178, 179 on the corner guide 175 may align with rails or tracks of a carrier (such as rails or tracks 277 and 298 of ADS 274, etc.), pallet supports of a pallet carrier (such as pallet supports 308 of pallet carrier 252, etc.) As illustrated in FIGS. 3A and 3B, the pallet carrier 170 may include various sensors 161, 172, 173, and 174. The sensors 161, 172, 173, and 174 may be any type sensors, such as inductive sensors, limit switches, etc. The sensors 161, 172, 173, and 174 may enable the processor of the vehicle vending machine (e.g., vending machine 100, 200, etc.) to determine whether or not a vehicle pallet is positioned on the lift-able shuttle 112 and whether or not the pallet carrier 170 is fully or partially retracted or extended in direction “A”. The turntable 160 of the lift-able shuttle 112 moves by means of a transmission chain operated by a central geared motor. This motor also has a frequency converter or drive that manages the speed and brake points according to the programmed parameters. The turning movement is important because it places the vehicle in the right position either to be stored when lifting, or to exit or enter the lift-able shuttle 112 when lowered.

The pallet carrier 170 picks up the vehicle pallet and places it on the lift-able shuttle 112. A further motor with frequency converter controls the speed of the sliding movement of the telescopic arms of the pallet carrier 170. The pallet carrier 170 has as a back-up system of two roller-lever operated limit switches, one at each end. These sensors may monitor an improbable wrong movement of the telescopic arms (e.g., over passing the delivery position). The telescopic arm picks up the pallet by engaging the two eyelets of the car-pallet with two cylindrical pins. An inductive proximity sensor may monitor that the pallet is engaged. The lift unit for the lift-able shuttle may include four motors and variable frequency drives, 4 chains, and 4 counterweights dimensioned to carry the lift-able shuttle 112 and its weight up and down the tower (e.g., tower 102, 102′, 273, etc.). The position and speed of the motors may be regulated by frequency inverters, each motor having a frequency inverter. The speed may be programmable; for instance, the lift-able shuttle 112 may be slowed down short before reaching the end position. The program may also monitor and compare the signals given by each frequency converter to ensure they are synchronized and the lift-able shuttle 112 is level.

In various embodiments, the operations of the vehicle vending machine (e.g., vending machine 100, 200, etc.) may be controlled by control panels, such as one or more control panels in the lobby 120 and/or offices 122. Additionally, the control panels may be portable. The control panels may be computing devices including processors configured to communicate with one or more processors of the vehicle vending machine controlling the various devices and systems within the vehicle vending machine. The control panels may be used to enable customers to select their vehicle and pick that vehicle up and by employees to perform various functions within the vehicle vending machine (e.g., vending machine 100, 200, etc.). For example, the control panels may enable customers and/or employees to initiate retrieval of a particular vehicle from the tower (e.g., tower 102, 102′, 273, etc.), initiate the opening or closing of the front gates to the bays 106a-d, and initiate the retrieval and/or delivery of pallets by the robotic carrier 114.

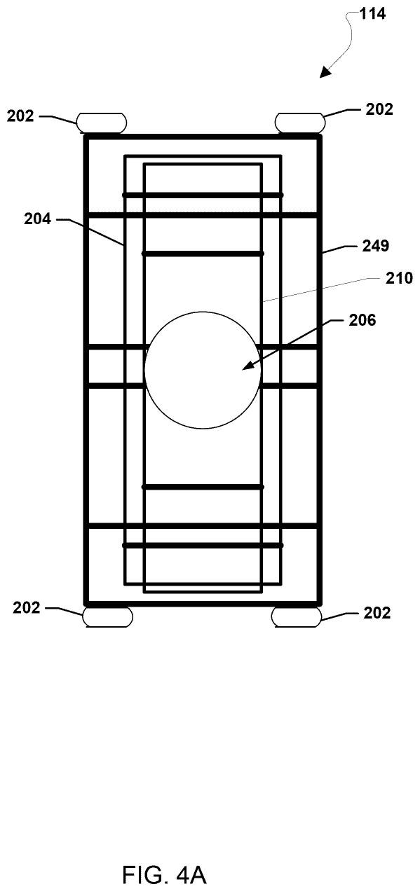

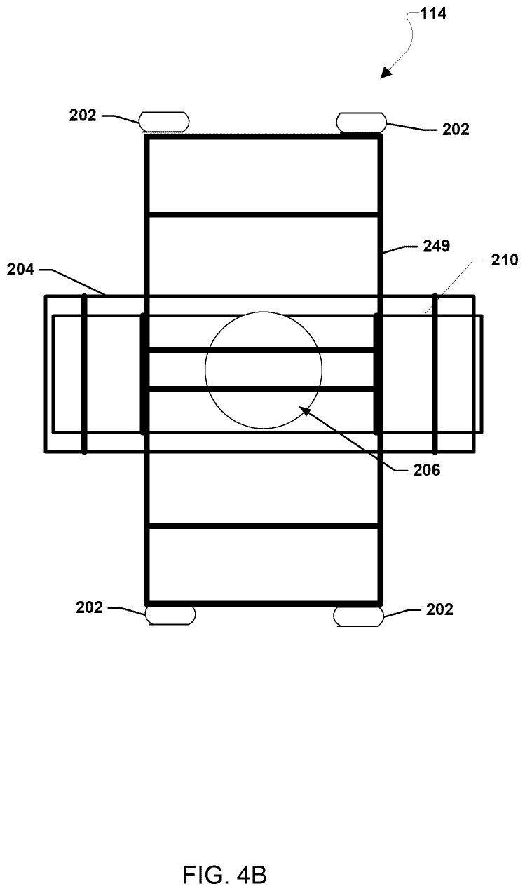

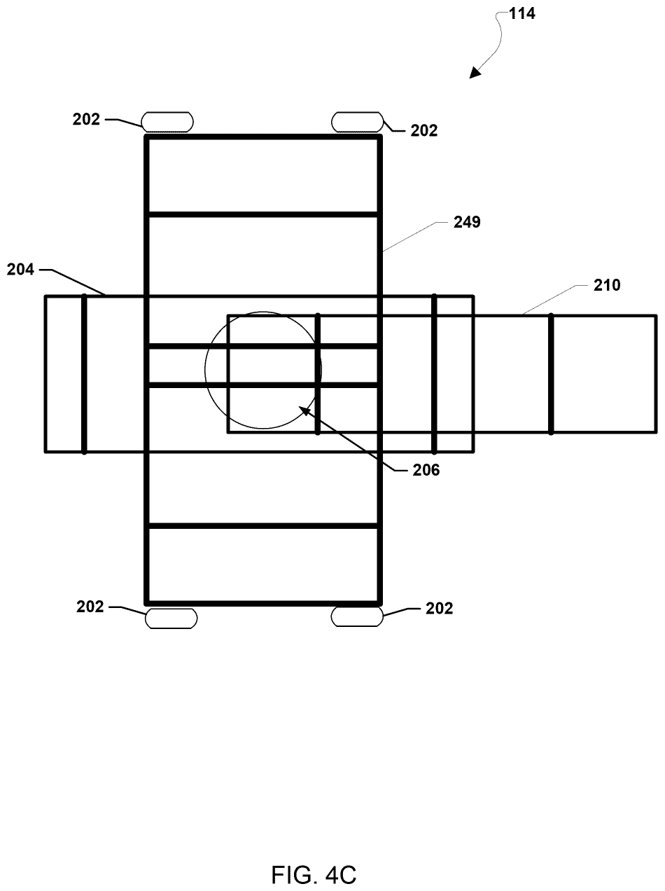

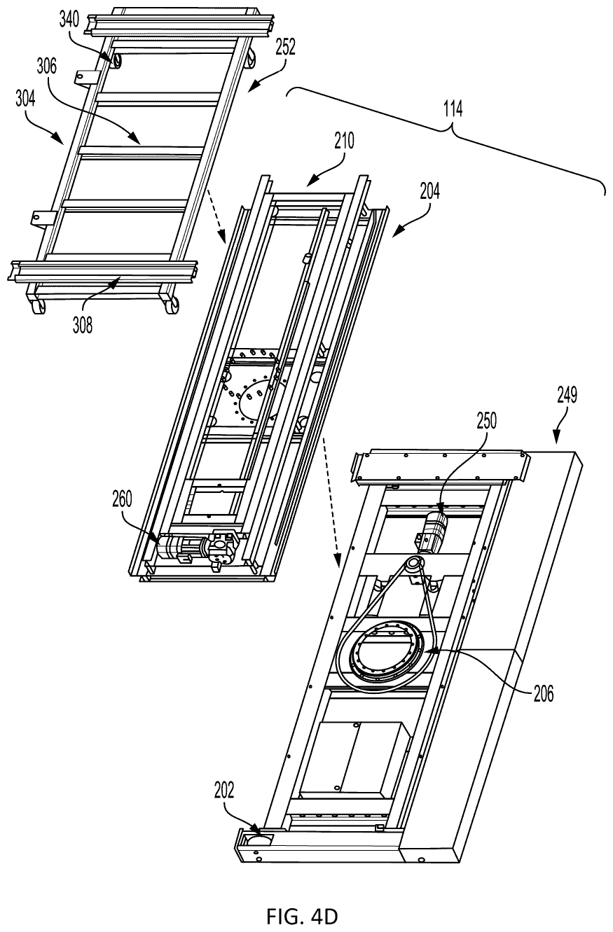

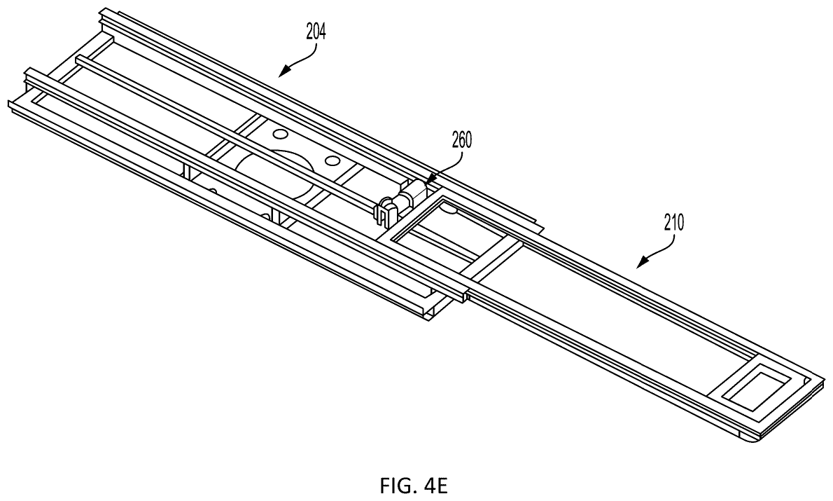

FIGS. 4A-4E illustrate various examples of a robotic carrier 114 for carrying a vehicle positioned on a vehicle pallet while navigating a corridor of a vehicle vending machine. The robotic carrier 114 may include a telescopic device 204 including a telescopic guide arm 210, and a gear or other rotation mechanism 206. In various embodiments, robotic carrier 114 may include wheels 202. In some embodiments, the wheels 202 may move along tracks 171 or rails by which the robotic carrier 114 may traverse an area of the vehicle vending machine. In other embodiments, the robotic carrier 114 may drive independent of tracks 171 or rails from one area to another. FIG. 4A illustrates the robotic carrier 114 fully collapsed or otherwise contained within a single space. FIG. 4B illustrates the robotic carrier 114 with the telescopic device 204 rotated at a 90° angle from the robotic carrier 114. FIG. 4C illustrates the robotic carrier 114 with the telescopic device 204 rotated at a 90° angle from the robotic carrier 114 and extended from the robotic carrier 114. FIG. 4D is an exploded diagram of the robotic carrier 114 and a pallet carrier 252 for carrying a vehicle pallet, such as vehicle pallets 142a-e described above. The pallet carrier 252 may be pulled onto the robotic carrier 114 by the telescopic guide arm 210 of the telescopic device 204 which may itself rest on top of the base 249 of the robotic carrier 114. The base 249 of the robotic carrier 114 may include the rotation mechanism 206 driven by a motor 250 that may rotate the telescopic device 204, telescopic guide arm 210, the pallet carrier 252, and any vehicle pallet thereon. A motor 260 on the telescopic device 204 may extend and retract the telescopic guide arm 210. Pallet carrier 252 may include an outer frame 304 and one or more cross-bars 306. Pallet carrier 252 may also include one or more pallet supports 308 and wheels 340. The pallet carrier 252 may include any number of wheels, such as two, four, or more wheels. FIG. 4E illustrates the telescopic device 204 with the telescopic guide arm 210 extended.

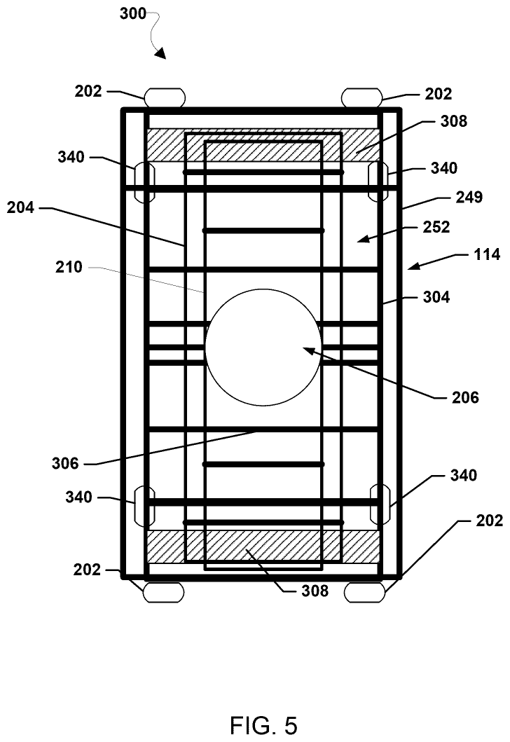

FIG. 5 illustrates an example of a system 300 for carrying a vehicle pallet on a robotic carrier, according to various embodiments. In some embodiments, the system 300 may include a pallet carrier 252 and robotic carrier 114 for carrying a vehicle pallet. In various embodiments, the pallet carrier 252 may be positioned on a robotic carrier, such as robotic carrier 114. In other embodiments, the pallet carrier 252 may be positioned or otherwise located in a location other than a robotic carrier. As such, pallet carrier 252 may be configured to be loaded onto and unloaded from the robotic carrier 114. In FIG. 5, the pallet carrier 252 is shown on the telescopic device 204.

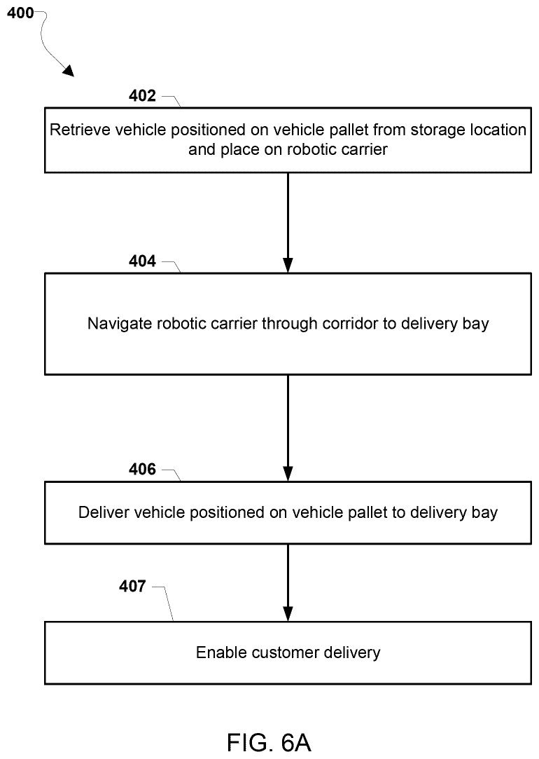

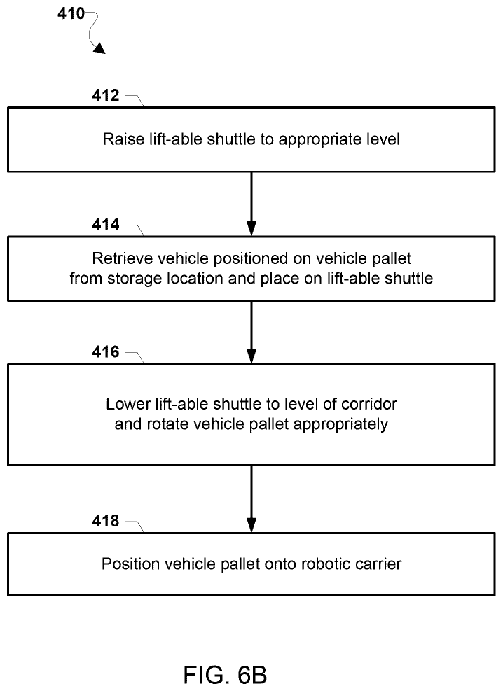

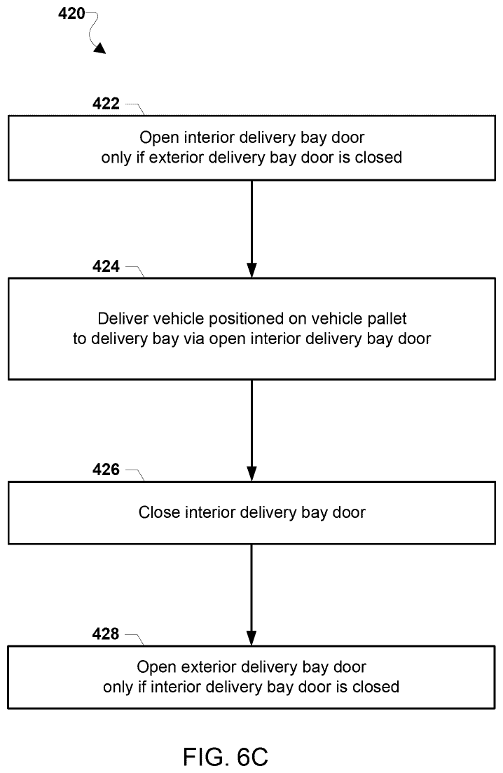

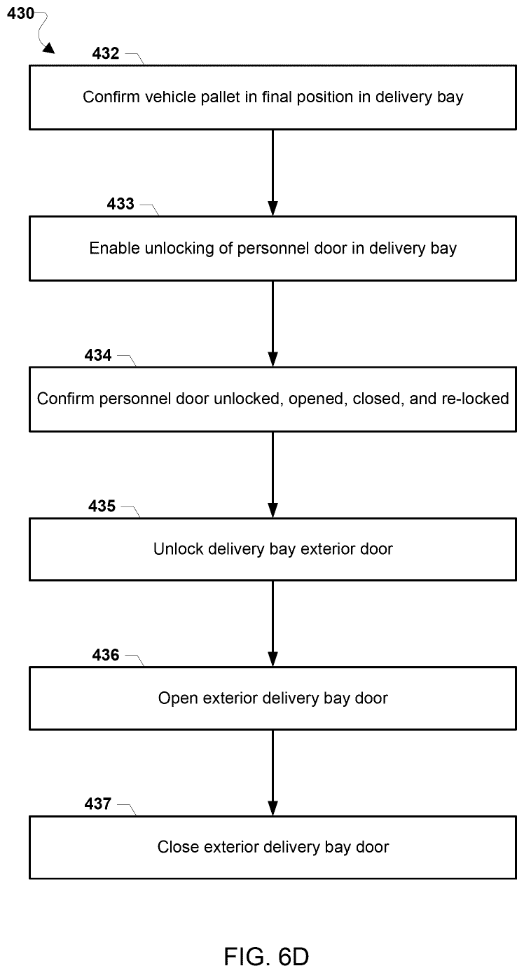

FIG. 6A illustrates a method 400 for operating a vehicle vending machine according to various embodiments. With reference to FIGS. 1A-6A, the operations of the method 400 may be performed by one or more processors of a vehicle vending machine (e.g., vehicle vending machine (e.g., vending machine 100, 200, etc.)). The vehicle vending machine may have sensors, cameras, and communication resources that may be used for retrieving a vehicle, navigating a corridor, and delivering a vehicle to a delivery bay.

In block 402, a vehicle positioned on a vehicle pallet may be retrieved from a storage location within a tower of a vehicle vending machine and placed on a robotic carrier. For example, if the vehicle is stored in a storage location on the fourth floor of the tower, a lift-able shuttle may be lifted to the fourth floor, the vehicle positioned on the vehicle pallet may be placed onto the lift-able shuttle, and the lift-able shuttle may be lowered to the level of a corridor of the vehicle vending machine. Once lowered, the vehicle positioned on a vehicle pallet may be placed on a robotic carrier. In various embodiments, the robotic carrier may be a delivery hitch that may a linear delivery system driven by a ball screw and guided by two track roller guide rails. This carrier that is the delivery hitch may connect the tower to the delivery bay through the corridor.

In block 404, the robotic carrier may navigate through a corridor to an appropriate delivery bay. In various embodiments, the robotic carrier may use a laser, a camera, and/or other sensors to monitor a position of the robotic carrier and traverse a path through the corridor. In some embodiments, the robotic carrier may include wheels that propel the robotic carrier along a floor of the corridor. In other embodiments, the corridor may include one or more tracks 171 or rails and the robotic carrier may be configured to follow the one or more tracks 171 or rails through the corridor. In some embodiments, the robotic carrier may be a delivery hitch that may a linear delivery system driven by a ball screw and guided by two track roller guide rails. The vehicle and pallet may be transitioned from the turntable of the shuttle to delivery hitch that may move the vehicle and pallet transversally along the track and roller guides into a selected delivery bay.

In block 406, the vehicle positioned on the vehicle pallet is delivered to a delivery bay. For example, upon arrival at an appropriate delivery bay, the robotic carrier may place the vehicle positioned on the vehicle pallet within the delivery bay. As another example, when the robotic carrier is a delivery hitch system, the drive motor of the ball screw may have a built-in encoder, when paired with the pitch of the ball screw, that may provide constant knowledge of the position of the pallet on the carrier. Once the pallet is correctly placed onto the carrier, a signal may be sent to the control system via a proximity sensor to initiate the remaining sequence to move the pallet into the delivery bay. Once this sequence is initiated, a ball screw drive may deliver the pallet down the corridor into the delivery bay into a “final position” which may be indicated by an embedded encoder inside of the ball screw drive motor.

In block 407, delivery to the customer of the vehicle in the delivery bay may be enabled. For example, one or more doors of the delivery bay may be opened to enable the vehicle to be driven off the vehicle pallet and out of the vehicle vending machine. Additionally, when the appropriate bay doors may already be open, the vehicle may be driven off the vehicle pallet by a customer and/or an employee.

FIG. 6B illustrates a method 410 for retrieving a vehicle from a storage location within a tower of a vehicle vending machine. With reference to FIGS. 1A-6B, the method 410 provides examples of operations that may be performed in block 402 of the method 400. The operations of the method 410 may be performed by one or more processors of a vehicle vending machine (e.g., vehicle vending machine (e.g., vending machine 100, 200, etc.)).

In block 412, a lift-able shuttle within the tower of the vehicle vending machine may be raised to an appropriate level of the tower. For example, if the vehicle is stored on the third level, the lift-able shuttle would be raised to the third level. In block 414, the vehicle positioned on a vehicle pallet is retrieved from the storage location and placed on the lift-able shuttle.

In block 416, the lift-able shuttle is lowered to the level of the corridor and the vehicle pallet is rotated appropriately. For example, the vehicle may have been stored in a storage location such that the vehicle is positioned perpendicular to the corridor while the vehicle needs to be positioned parallel to the corridor in order to be transported by a robotic carrier. In this example, the vehicle pallet (and the vehicle positioned on the vehicle pallet) would be rotated from the perpendicular position to the parallel position. As another example, the vehicle pallet (and the vehicle positioned on the vehicle pallet) may be positioned to slide sideways through the corridor. Additionally, in some embodiments, more than one corridor may be connected to the tower. In such embodiments, the vehicle pallet (and the vehicle positioned on the vehicle pallet) may be oriented to align with the appropriate corridor along which the vehicle is to transit toward a selected delivery bay.

In block 418, the vehicle pallet is positioned onto the robotic carrier. For example, the vehicle pallet (and vehicle positioned on the vehicle pallet) may be moved or otherwise transferred from the lift-able shuttle to the robotic carrier via an opening in the tower.

FIG. 6C illustrates a method 420 for delivering a vehicle to a delivery bay of a vehicle vending machine. With reference to FIGS. 1A-6C, the method 420 provides examples of operations that may be performed in block 406 of the method 400. The operations of the method 420 may be performed by one or more processors of a vehicle vending machine (e.g., vehicle vending machine (e.g., vending machine 100, 200, etc.)).

In block 422, an interior delivery bay door may be opened only if an exterior delivery bay door is closed. In various embodiments, conditions within an empty delivery bay or within a corridor of the vehicle vending machine may be dangerous or otherwise unfit for a customer to enter. In some embodiments, delivery of a vehicle into a delivery bay may pose a risk to an individual standing or otherwise located in the delivery bay. As such, the interior delivery bay door may only be opened if the exterior delivery bay door is closed, thus ensuring no individual is present within the delivery bay.

In block 424, a vehicle positioned on a vehicle pallet may be delivered to the delivery bay via the open interior delivery bay door. For example, a telescopic device (e.g., 204) may be extended from a robotic carrier (e.g., 114), thus pushing or otherwise moving a pallet carrier (e.g., 302) into the delivery bay.

In block 426, the interior delivery bay door may be closed. In block 428, the exterior delivery bay door may be opened only if the interior delivery bay door is closed. The corridor and other areas within the vehicle vending machine may be inappropriate for a customer or other individual without specialized training. As such, the exterior door may be opened only if the interior door is closed to ensure the safety and well-being of a customer while precluding unwanted intrusion into the corridor or other inappropriate areas of the vehicle vending machine.

FIG. 6D illustrates a method 430 for delivering a vehicle to delivery location outside the vehicle vending machine. With reference to FIGS. 1A-6D, the method 430 provides examples of operations that may be performed in block 407 of the method 400. The operations of the method 430 may be performed by one or more processors of a vehicle vending machine (e.g., vehicle vending machine (e.g., vending machine 100, 200, etc.)). The method 430 may be performed after the carrier of the vehicle vending machine has been in operation to traverse a vehicle pallet with a vehicle on it from the tower to the delivery bay.

In block 432, the position of the vehicle pallet with the vehicle on it being in the final position in the delivery bay may be confirmed. For example, when a ball screw drive may deliver the pallet down a corridor and into the delivery bay, the pallet being in the “final position” may be indicated by an embedded encoder inside of the ball screw drive motor. The processor (e.g., a controller) of the vehicle vending machine may confirm the position via outputs from the ball screw drive motor. In some embodiments, only after the pallet is confirmed in the final position may the method proceed from block 432.

In block 433, the personnel door in the delivery bay may be enabled to be unlocked. In various embodiments, while the lift-able shuttle and/or carrier of the vehicle vending machine are in operation, one or more doors to the delivery bay may remain locked, such as the external delivery bay door and the personnel door. In various embodiments, when the vehicle pallet is in the final position in the delivery bay, an employee may unlock the personnel door, such as via his or her control panel (e.g., tablet computing device). For example, the tablet computing device may indicate the personnel door is enabled to be unlocked in response to a signal from the vehicle vending machine and the employee may use the tablet computing device to unlock the personnel door. As a specific example, the signal from the tablet computing device having a specific SSID may unlock the personnel door. The employee may open the personnel door and thereby enter the delivery bay. The employee may close and lock the personnel door and enter the vehicle on the vehicle pallet.

In block 434 the unlocking, opening, closing, and relocking of the personnel door may be confirmed. This series of operations may be indicted by tracking signals from the control panel and by sensors on the personnel door itself. In some embodiments, only after the operations of unlocking, opening, closing, and relocking are confirmed may the method proceed from block 434.

In block 435, the delivery bay exterior door may be unlocked. The unlocking of the delivery bay exterior door may be automatic in response to the confirmation in block 434. In block 436, the delivery bay exterior door may be opened. For example, an employee in the vehicle may use a control panel that is a tablet computing device to open the delivery bay exterior door by pressing an open button on the graphical user interface. In response, the exterior door may slide open, and the employee may drive the vehicle off the pallet and out of the delivery bay to an external delivery position outside the vehicle vending machine. In block 437, the delivery bay exterior door may close. The closing of the door may be in response to an employee input to a control panel and/or may be automatic after removal of the vehicle from the delivery bay.

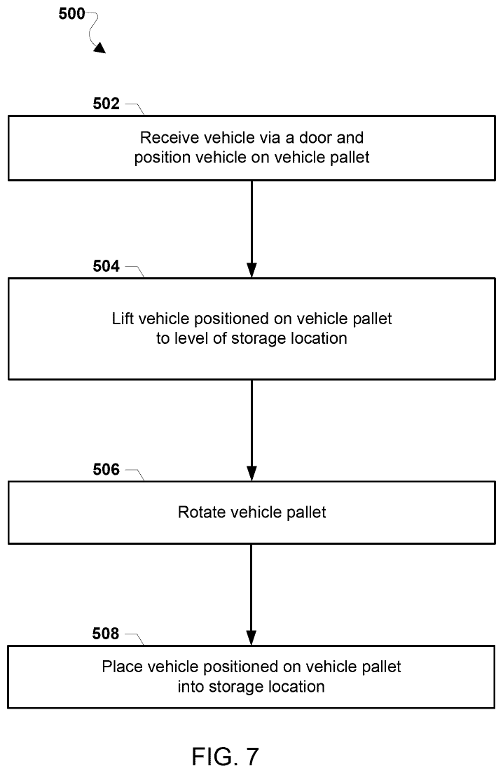

FIG. 7 illustrates a method 500 for storing a vehicle in a tower of a vehicle vending machine. With reference to FIGS. 1A-7, the operations of the method 500 may be performed by one or more processors of a vehicle vending machine (e.g., vehicle vending machine (e.g., vending machine 100, 200, etc.)). In block 502, a vehicle may be received via a door of the tower (e.g., exterior door 108, tower loading door 286, etc.) and positioned on a vehicle pallet. For example, the vehicle pallet may be resting on a lift-able shuttle of the tower and the vehicle may be driven through the exterior door (or through the tower loading door from the vehicle preparation area) until the vehicle is positioned directly on the vehicle pallet. Alternatively, or in addition, the vehicle may be pushed or pulled through the door of the tower (e.g., exterior door 108, tower loading door 286, etc.) until the vehicle is positioned on the vehicle pallet. In various embodiments, the operations of block 502 may occur after the vehicle has been prepared in a vehicle preparation area and after the vehicle has been driven into the vehicle vending machine, such as into the vehicle preparation area, through an external door of the vehicle vending machine.

In block 504, the vehicle positioned on the vehicle pallet may be lifted to an appropriate level for a storage location. For example, the tower may include four (4) levels and the vehicle may need to be stored in a storage location on the third level. In some embodiments, a lift-able shuttle of the tower may be raised to the appropriate level (i.e., third level).

In block 506, the vehicle pallet is rotated to an appropriate orientation. For example, if the storage location is located along one wall of the tower and the exterior door is located along a wall opposite the storage location, the vehicle pallet (and vehicle positioned on the vehicle pallet) may be positioned perpendicular to the storage location. As such, the vehicle pallet may be rotated until the vehicle pallet (and vehicle positioned on the vehicle pallet) is oriented parallel to the storage location. In block 508, the vehicle positioned on the vehicle pallet is placed into the storage location.

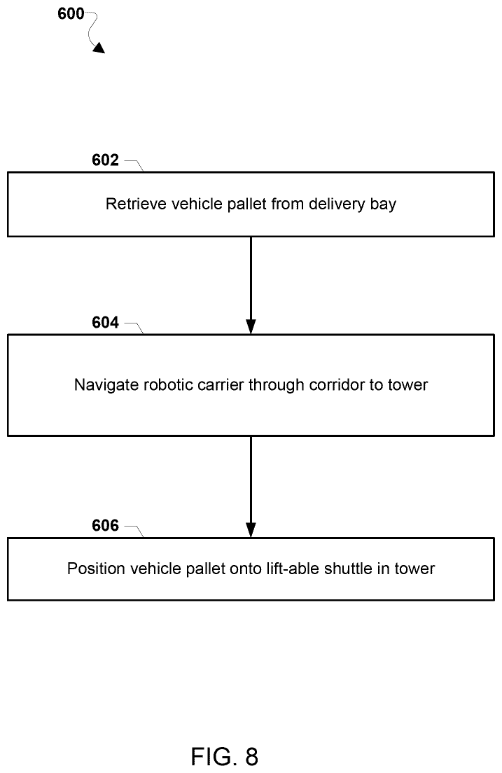

FIG. 8 illustrates a method 600 for retrieving a vehicle pallet from a delivery bay of a vehicle vending machine. With reference to FIGS. 1A-8, the operations of the method 600 may be performed by one or more processors of a vehicle vending machine (e.g., vehicle vending machine (e.g., vending machine 100, 200, etc.)). In some embodiments, the vehicle pallet may be empty. In other embodiments, a vehicle may be positioned on the vehicle pallet. For example, after inspecting or otherwise reviewing the vehicle, a customer may decide to not take delivery of the vehicle, in which case the vehicle may need to be returned to storage.

In block 602, the vehicle pallet may be retrieved from the delivery bay. In some embodiments, an interior delivery bay door may only be opened if an exterior delivery bay door is closed. In some embodiments, a telescopic device (e.g., 204) may be extended from a robotic carrier (e.g., 114) and hook or otherwise engage a pallet carrier (e.g., 302) in order to retrieve the vehicle pallet. In some embodiments, the delivery hitch (e.g., 275) may be retracted after the exterior delivery bay door is closed.

In block 604, a robotic carrier may navigate through a corridor of the vehicle vending machine. For example, after retrieving the vehicle pallet from the delivery bay, the robotic carrier may carry the vehicle pallet back through the corridor to a tower of the vehicle vending machine. As another example, the

ADS may traverse a delivery hitch (e.g., 275) from the delivery bay through the corridor to the tower.

In block 606, the vehicle pallet is positioned onto a lift-able shuttle of the tower. For example, the vehicle pallet may be pushed or otherwise delivered through an opening between the tower and the corridor. Once returned to the tower, the vehicle pallet (either empty or with a vehicle positioned on the vehicle pallet) may be placed into a storage location or, if empty, a vehicle may be positioned onto the empty vehicle pallet.

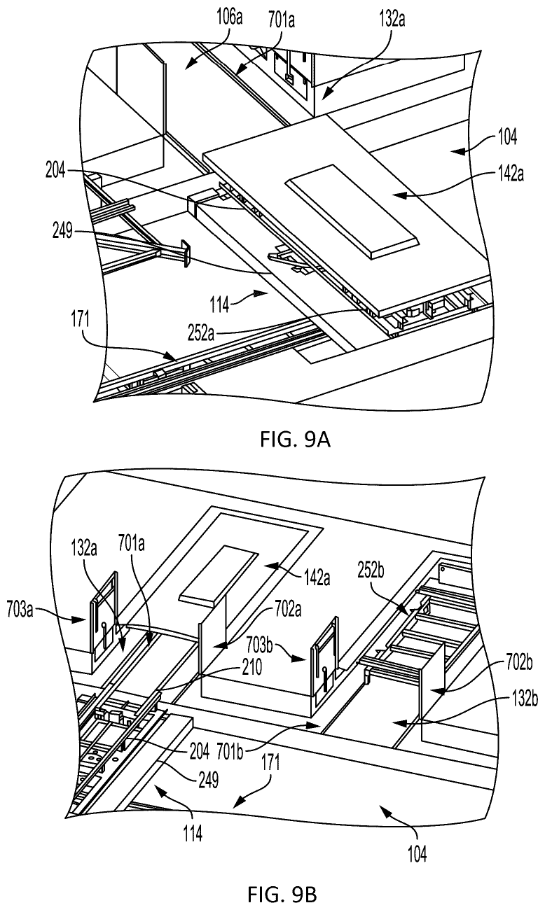

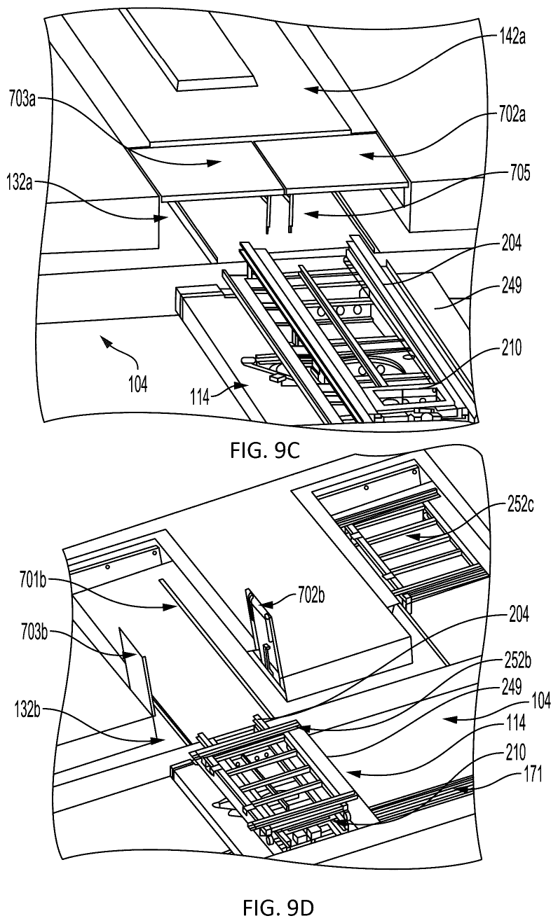

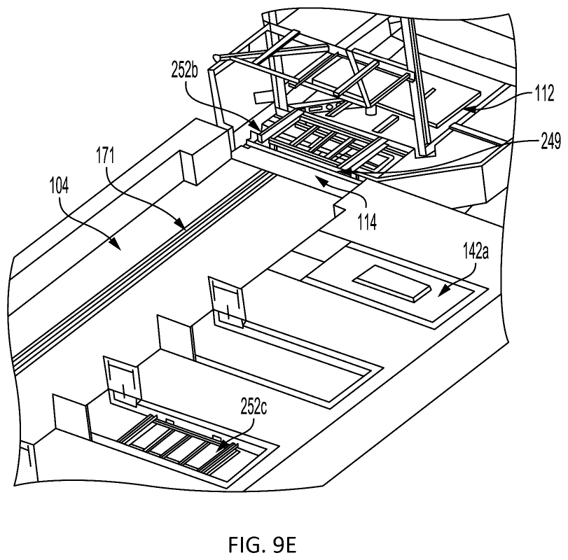

FIGS. 9A-9E illustrate movements of a vehicle pallet in a vehicle vending machine according to various embodiments. With reference to FIGS. 1A-9E, the robotic carrier 114 for carrying a vehicle may carry the vehicle pallet 142a down the corridor 104 to outside delivery bay 106a and interior door opening 132a as shown in FIG. 9A. The vehicle pallets 142a may be supported by a pallet carrier 252a on the base 249 of the robotic carrier 114. The robotic carrier 114 may traverse the corridor 104 on track (or rail) 170. Tracks (or rails) 701a within the delivery bay 106a may be configured to receive the pallet carrier 252a supporting the vehicle pallet 142a. No vehicle is illustrated on the vehicle pallet 142a in FIGS. 9A-9E for ease of illustration; however, a vehicle for delivery to the bay 106a could be supported by the vehicle pallet 142a. The back portion of the bay 106a floor may split into two portions 702a and 703a that may lift up to allow the pallet carrier 252a supporting the vehicle pallet 142a to enter the bay 106a. When folded down, floor portions 702a and 703a may be at a height equal to the height of the vehicle pallet 142a, and the pallet 142a and floor portions 702a and 703b may form an elevated deck above the actual floor of the bay 106a. Additionally, the floor of the corridor 104a may be recessed below the actual floor of the bay.

Referring to FIG. 9B, the telescopic guide arm 210 may extend from the telescopic device 204 to insert the pallet carrier 252a and vehicle pallet 142a into the bay 106a. The pallet carrier 252a may slide along the tracks (or rails 701a) in the bay 106a. FIG. 9B also illustrates a second pallet carrier 252b in bay 106b ready for pick-up by the robotic carrier 114.

In various embodiments, the delivery bays 106a and 106b are placed one next to the other alongside the corridor 104. The delivery bays include access doors, as well as floor compensation mechanisms. The floor in the delivery bays is prepared with a pit in the right size for the reception of the pallet carriers 252 bringing the vehicle on a pallet 142. The delivery bays may have 2 gates, the back- and the front-doors or gates. These doors are integrated in the automation of the vehicle vending machine and include a back and front gate. The front gate is the access for the customer from the street, and the back gate is a safety barrier closing the access of people to the area where the moving parts of the vehicle vending machine operate. Gates may include safety features such as manual opening, emergency stop, contact strips, etc. The back-gate enables the access of the pallet carriers 252 from the corridor 104 into the bays 106a-d. After placing the vehicle in the bay 106a, the telescopic guide arm 210 retracts and the back-gate to the corridor 104 will close automatically. The position of the pallet 142a may be calculated by the motor-inverter of the robotic carrier 114. After the pallet 142a is correctly placed, the floor compensation mechanism formed from the two floor portions 702a and 703a will be activated. This closes the pit behind the car pallet 142a to enable a flat a level surface all around the car for the customer to transit the area. For example, the floor mechanism may be 2-leaf hatch formed from floor portions 702a and 703a, each leaf controlled by electric motors. An inductive sensor per electrical motor may signal that the hatch is closed allowing the front door to unlock. The same sensor signal position open allowing the back door to open and the robotic carrier 114 to bring in the car pallet 142a. The vehicle vending machine may only unlock the front-gate when the car is safely parked in the delivery bay, the robotic carrier 114 has left the bay, and the back-gate is closed. The actual opening of the front-gate may be executed by an employee via a control panel when the customer is in place. When the employee leaves the bay, he or she may close the gate via the control panel. After a visual inspection of the inside of the bay, if there are neither obstacles nor people in the bay, the employee may give clearance to the vehicle vending machine via the control panel and the empty pallet will be picked up at the next possibility.

FIG. 9C illustrates the floor portions 702a and 703a in a closed position and supported above the bay 106a floor by legs 705. The telescopic guide arm 210 is retracted back into the robotic carrier 114. FIG. 9D shows the robotic carrier 114 retrieving the pallet carrier 252b from the bay 106b. Floor portions 702b and 703b of bay 106b are elevated and open and the pallet carrier 252b is retracted with the telescopic guide arm 210 back on the robotic carrier 114. A third pallet carrier 252c in another bay is also visible in FIG. 9D. FIG. 9E shows the robotic carrier 114 after traversing the corridor 104 back to the tower 102 to await delivery of another vehicle pallet and vehicle onto the pallet carrier 252b. The robotic carrier 114 moved from bay 106b to the tower 102 and is positioned next to the lift-able shuttle 112 to receive a vehicle pallet and vehicle.

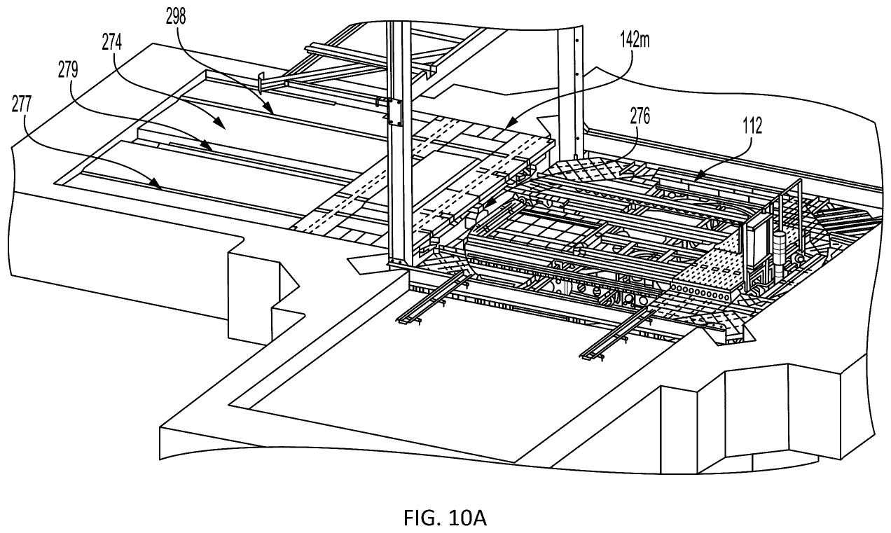

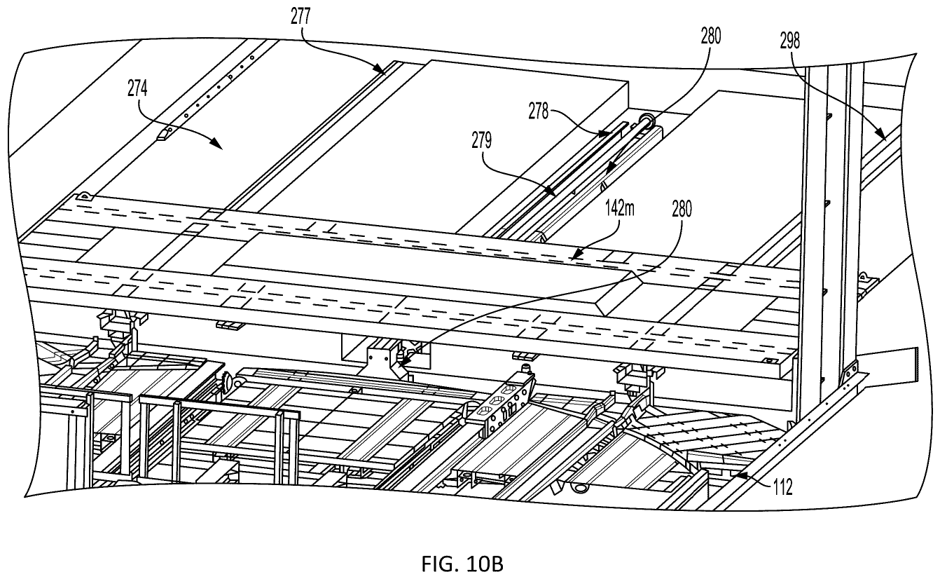

FIGS. 10A and 10B are block diagrams illustrating components of a vehicle vending machine robotic carrier system that uses a delivery hitch according to various embodiments. Specifically, FIGS. 10A and 10B illustrate different views of a carrier, such as an ADS 274, that may be arranged in the corridors leading to the delivery bays in a vehicle vending machine, such as vehicle vending machine 200. FIGS. 10A and 10B show an empty vehicle pallet 142m that has been moved from the lift-able shuttle 112 into a corridor for transport to a delivery bay. The ADS 274 may be a robotic carrier configured to traverse the pallet 142m from the lift-able shuttle 112 in the tower through a respective corridor and into a respective delivery bay and back again. The ADS 274, a type of robotic carrier, may be a delivery hitch 275 that may a linear delivery system driven by a ball screw 279 and guided by two track roller guide rails 278 and 280. The delivery hitch 275 may be connected to the guide tracks 278, 280 via four profiled track rollers on a shaft, and two flat track rollers onto the top of the guide track channel. There may be a guide track 278, 280 on two sides of the delivery hitch 275, and a ball screw 279 that lies on the central axis of this carrier system. The delivery hitch 275 may have six track rollers. Two track rollers may be steel ball bearings with a flat outer bearing contact surface. Four track rollers may be steel ball bearings with a profiled outer bearing contact surface to provide the hitch 275 with lateral stability when paired with a shaft. The drive motor 276 of the ball screw 279 may have a built-in encoder, when paired with the pitch of the ball screw 279, that may provide constant knowledge of the position of the pallet on the carrier. The range of travel of the delivery hitch 275 may be programmed into the system to prevent over-travel. There may be a proximity switch that detects when a pallet is properly loaded onto the delivery hitch 275. Once the pallet is positioned onto the delivery hitch 275, it will depress a spring-loaded steel plate that will position in front of the proximity switch. This switch may then send the “OK” signal to the system to proceed with delivery operations.

In various embodiments, the corridors connecting the tower to the delivery bays, respectively, may be prepared with a recess which will allow for the top of the pallet 142m to be flush with the floor of the delivery bays. Additionally, the recessed portion of the delivery bays floors may have a pit that lies along the centerline of the bays which may house portions of the robotic carrier (e.g., ADS 274 and its associated equipment). The corridors may be configured not to be transited by any customers or employees. Once the pallet 142m is correctly placed onto the carrier (e.g., on delivery hitch 275), a signal may be sent to the control system via a proximity sensor to initiate the remaining sequence to move the pallet 142m into the respective delivery bay. Once this sequence is initiated, the ball screw drive 279 may deliver the pallet 142m down the corridor into the respective delivery bay into a “final position” which may be indicated by an embedded encoder inside of the ball screw drive motor 276. Wheels on the underside of the vehicle pallet 142m may be arranged perpendicular to the storage direction of a vehicle on the pallet 142m and may slide along rails or tracks 277 and 298 extending through the corridor and into the delivery bay to enable to the pallet 142m to be moved laterally through the corridor and delivery bay by the movement of the delivery hitch 275 driven by the rotation of the ball screw 279 shaft.

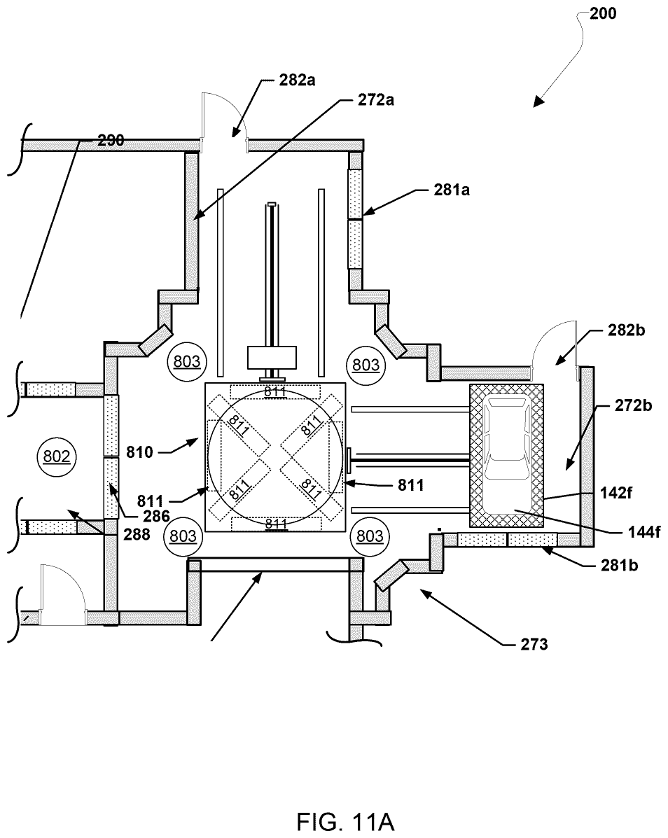

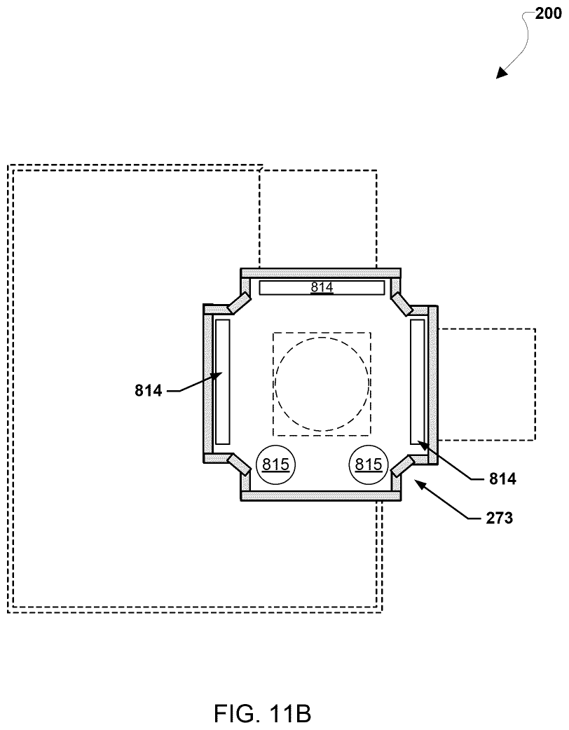

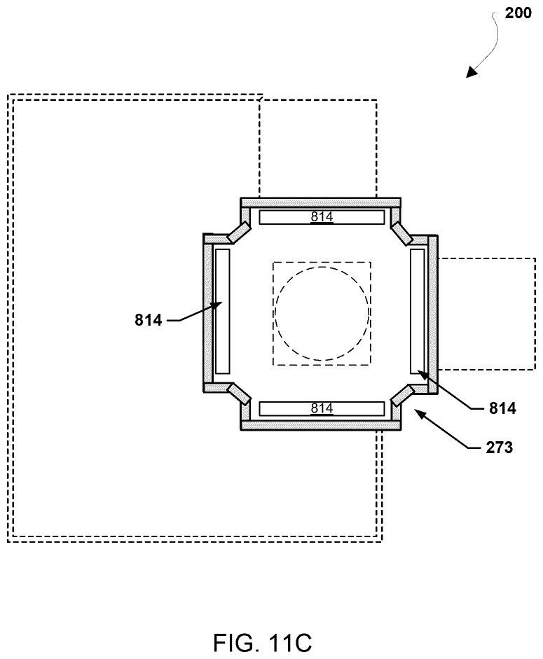

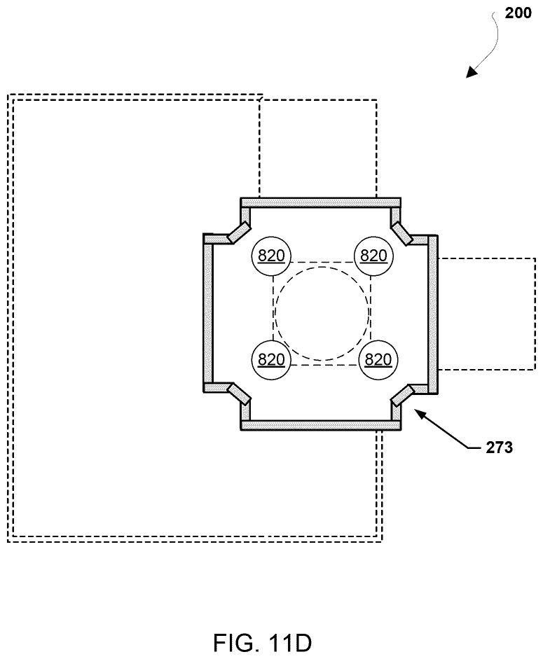

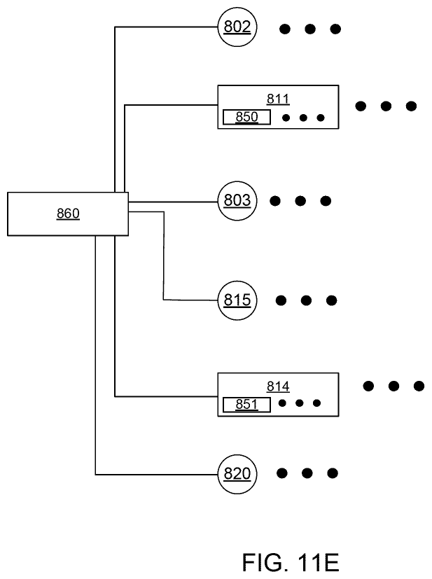

FIG. 11A illustrates example lighting installations in the example vehicle vending machine 200 according to various embodiments. FIG. 11A is a ground floor cut-away view of a portion of the vehicle vending machine 200 illustrating the inside of the vehicle vending machine 200 and example lighting installations therein. FIG. 11B illustrates an example second floor, e.g., the floor immediately above the ground floor, floor cut-away view of inside of the vehicle vending machine 200 specifically showing example lighting installations for that second level of the vehicle vending machine 200. FIG. 11C illustrates an example upper floor, e.g., a floor on a different vertical level than the ground floor illustrated in FIG. 11A, floor cut-away view of inside of the vehicle vending machine 200 specifically showing example lighting installations for that upper level of the vehicle vending machine 200. FIG. 11D illustrates an example ceiling cut-away view of inside of the vehicle vending machine 200 specifically showing example lighting installations for the upper inside roof of the vehicle vending machine 200. FIG. 11E is a component block diagram illustrating network connections between example lighting installations in a lighting system of a vehicle vending machine 200. With reference to FIGS. 1A-11E, the lighting installations illustrated in, and described with reference to, FIGS. 11A-11E are merely examples of lighting installations according to various embodiments. Additional lights, less lights, alternative light placements, and/or alternative light arrangements on levels of the vehicle vending machine 200 may be substituted for the examples in FIGS. 11A-11E in various embodiments. In various embodiments, different levels of the vehicle vending machine 200 may include different lighting fixtures, such as the ground floor including different lighting fixture configurations than middle levels of the tower, different middle levels having different lighting fixture configurations, an upper roof of the vehicle vending machine 200 having a different lighting fixture configuration, etc.

As one example, the ground floor of the vehicle vending machine 200 (or lower floor of the vehicle vending machine 200 including the delivery bays) as illustrated in FIG. 11A may include one or more lighting fixtures 802 in the vehicle preparation area 288. As one example, the one or more lighting fixtures 802 may be a tri-color OLED (e.g., red-green-blue (RGB) OLED, etc.) wash light. As specific examples, the one or more lighting fixtures 802 may be one, two, three, or more RGB OLEDs. The one or more lighting fixtures 802 may be connected (e.g., via wired and/or wireless connections) to a controller 860 configured to control the operation of the one or more lighting fixtures 802. As an example, the one or more lighting fixtures 802 may be turned on, turned off, dimmed, changed in output color, strobe flashed, etc. The controller 860 may control the operation of the one or more lighting fixtures 802 according to one or more lighting control programs or sequences, such as a lighting control sequence associated with a vehicle being moved from the vehicle preparation area 288 to the loading area 273a. As one example, the controller 860 may be a processor of a computing device of a control system of a vehicle vending machine (e.g., 100, 200, etc.), such as a processor of a control panel of the vehicle vending machine (e.g., 100, 200, etc.). The controller 860 may be configured such that an employee or other user may configure the lighting sequences or programs for the vehicle vending machine (e.g., 100, 200, etc.) via inputs to the control panel.

As another example, the ground floor of the vehicle vending machine 200 (or lower floor of the vehicle vending machine 200 including the delivery bays) as illustrated in FIG. 11A may include one or more lighting fixtures 803 in the tower 273, such as one, two, three, four, five, or more lighting fixtures 803 in loading area 273a of the tower 273 and/or arranged around the lift-able shuttle 112. As a specific example, the lighting fixtures 803 may be four lighting fixtures 803 each arranged at the base of main columns the lifting system for the lift-able shuttle 112. As one example, the one or more lighting fixtures 803 may be moveable (e.g., actuatable) OLED wash lights, such a RGB LED wash lights, etc. The one or more lighting fixtures 803 may be connected (e.g., via wired and/or wireless connections) to the controller 860 configured to control the operation of the one or more lighting fixtures 803. As an example, the one or more lighting fixtures 803 may be turned on, turned off, dimmed, changed in output color, strobe flashed, rotated, panned, tilted, focused, etc. The controller 860 may control the operation of the one or more lighting fixtures 803 according to one or more lighting control programs or sequences, such as a lighting control sequence associated with a vehicle being lifted on the lift-able shuttle 112, a vehicle being rotated on the lift-able shuttle 112, a vehicle being lowered on the lift-able shuttle 112, etc.

As a further example, the ground floor of the vehicle vending machine 200 (or lower floor of the vehicle vending machine 200 including the delivery bays) as illustrated in FIG. 11A may include a set 810 of one or more lighting fixtures 811 configured to illuminate the lift-able shuttle 112. As a specific example, the set 810 of lighting fixtures 811 may be a set of light bar type lighting fixtures 811, such as one, two, three, four, five, six, seven, eight, nine, ten, or ten or more lighting fixtures 811. Each lighting fixture 811 may include a number of separately controllable light bar 850 type lighting fixtures, such as one, two, three, three or more light bars 850, etc. As an example, the one or more light bar 850 forming each lighting fixture 811 may be a strip type light, such as a strip type LED having a number of lights (e.g., bulbs, LEDs, etc.), such as one to twenty-five lights, twenty-five to fifty lights, fifty to a hundred lights, a hundred or more lights, etc. The lights of the light bars 850 may be any type lights, such as color changing lights (e.g., RGB LEDs, etc.). The set 810 of one or more lighting fixtures 811 may be connected (e.g., via wired and/or wireless connections) to the controller 860 configured to control the operation of the one or more lighting fixtures 811. As an example, the set 810 of one or more lighting fixtures 811 may be turned on, turned off, dimmed, changed in output color, strobe flashed, etc. The controller 860 may control the operation of the set 810 of one or more lighting fixtures 811 according to one or more lighting control programs or sequences, such as a lighting control sequence associated with a vehicle being lifted on the lift-able shuttle 112, a vehicle being rotated on the lift-able shuttle 112, a vehicle being lowered on the lift-able shuttle 112, etc.

As another example, an upper floor of the vehicle vending machine 200 (e.g., a floor above the ground floor of the vehicle vending machine 200, such as the second, floor, third, floor, etc.) as illustrated in FIG. 11B may include one or more lighting fixtures 815 in the tower 273, such as one, two, three, four, five, or more lighting fixtures 815 on the upper level of the tower 273. As a specific example, the lighting fixtures 815 may be two lighting fixtures 815 each arranged near (e.g., alongside, above, etc.) the glass wall 285 (or otherwise transparent wall, such as a windowed wall, etc.) that provides a view of the operations of the tower 273. As specific examples, the lighting fixtures 815 may be mounted to a wall of the tower 273. As one example, the one or more lighting fixtures 815 may be moveable (e.g., actuatable) OLED wash lights. The one or more lighting fixtures 815 may be connected (e.g., via wired and/or wireless connections) to the controller 860 configured to control the operation of the one or more lighting fixtures 815. As an example, the one or more lighting fixtures 815 may be turned on, turned off, dimmed, changed in output color, strobe flashed, rotated, panned, tilted, focused, etc. The controller 860 may control the operation of the one or more lighting fixtures 815 according to one or more lighting control programs or sequences, such as a lighting control sequence associated with a vehicle being lifted on the lift-able shuttle 112, a vehicle being rotated on the lift-able shuttle 112, a vehicle being lowered on the lift-able shuttle 112, a vehicle being moved to a delivery bay, etc.

As another example, an upper floor of the vehicle vending machine 200 (e.g., a floor above the ground floor of the vehicle vending machine 200, such as the second, floor, third, floor, etc.) as illustrated in FIGS. 11B and/or 11C may include one or more lighting fixtures 814 configured to illuminate the storage locations in the tower 273. As a specific example, the lighting fixtures 814 may be light bar type lighting fixtures hanging from an upper portion (e.g., ceiling portion) of the storage locations in the tower 273. Each lighting fixture 814 may include a number of separately controllable light bar 851 type lighting fixtures, such as one, two, three, three or more light bars 851, etc. As an example, the one or more light bar 851 forming each lighting fixture 814 may be a strip type light, such as a strip type LED having a number of lights (e.g., bulbs, LEDs, etc.), such as one to twenty-five lights, twenty-five to fifty lights, fifty to seventy-five lights, seventy-two lights, seventy-five to a hundred lights, a hundred or more lights, etc. The lights of the light bars 851 may be any type lights, such as color changing lights (e.g., RGB LEDs, etc.). The one or more lighting fixtures 814 may be connected (e.g., via wired and/or wireless connections) to the controller 860 configured to control the operation of the one or more lighting fixtures 814. As an example, the one or more lighting fixtures 814 may be turned on, turned off, dimmed, changed in output color, strobe flashed, etc. The controller 860 may control the operation of the one or more lighting fixtures 814 according to one or more lighting control programs or sequences, such as a lighting control sequence associated with a vehicle being lifted on the lift-able shuttle 112, a vehicle being rotated on the lift-able shuttle 112, a vehicle being lowered on the lift-able shuttle 112, a vehicle being positioned in the storage location, a vehicle being removed from the storage location, etc. In some embodiments, different levels of the tower 273 may include different numbers of one or more lighting fixtures 814. For example, a second level may include three lighting fixtures 814 as illustrated in FIG. 11B and levels above the second level may include four lighting fixtures 814 as illustrated in FIG. 11C. More or less lighting fixtures 814 may be included on various levels of the tower 273.

As one example, an upper floor of the vehicle vending machine 200, such as a top floor (or roof) of the tower 273 as illustrated in FIG. 11D may include one or more lighting fixtures 820 in the center portion of the tower 273. The lighting fixtures 820 may be configured to illuminate the center portion of the tower 273. As one example, the one or more lighting fixtures 820 may be tri-color OLED (e.g., RGB OLED, etc.) wash lights. As specific examples, the one or more lighting fixtures 820 may be one, two, three, or more RGB OLEDs. The one or more lighting fixtures 820 may be connected (e.g., via wired and/or wireless connections) to the controller 860 configured to control the operation of the one or more lighting fixtures 820. As an example, the one or more lighting fixtures 820 may be turned on, turned off, dimmed, changed in output color, strobe flashed, etc. The controller 860 may control the operation of the one or more lighting fixtures 820 according to one or more lighting control programs or sequences, such as a lighting control sequence associated with a vehicle being lifted in the tower 273 and/or lowered in the tower 273.

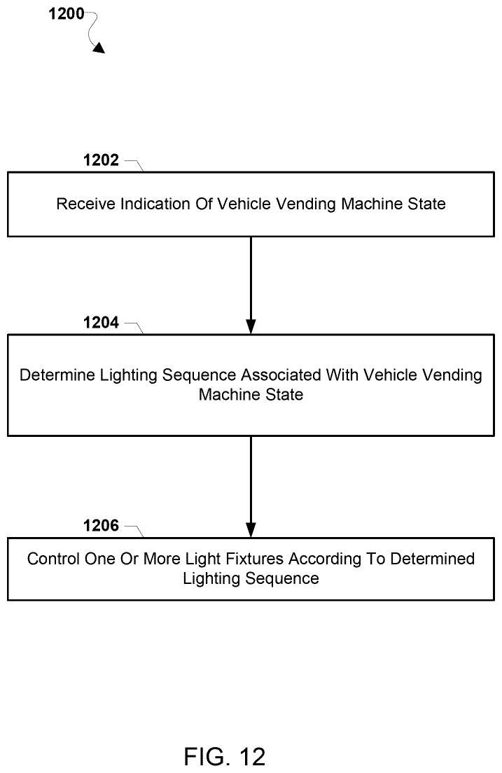

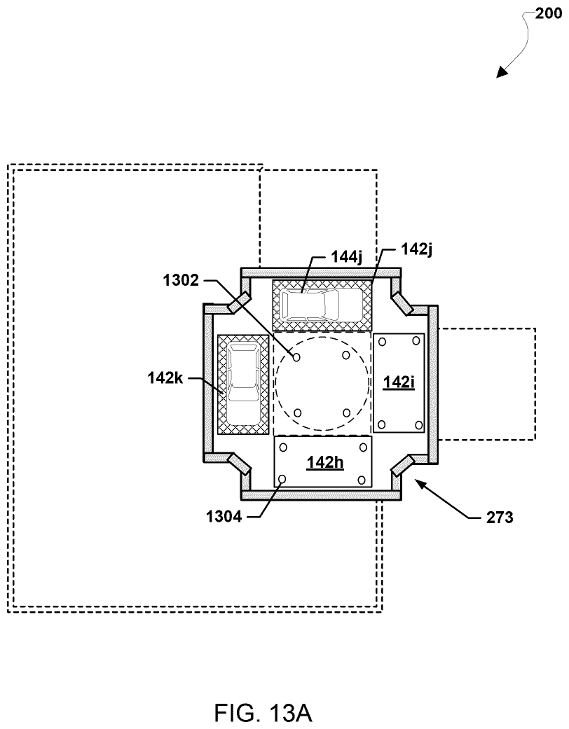

FIG. 12 illustrates a method 1200 for controlling a lighting system for a vehicle vending machine, according to various embodiments. With reference to FIGS. 1A-12, the operations of the method 1200 may be performed by one or more processors of a vehicle vending machine (e.g., vehicle vending machine (e.g., vending machine 100, 200, etc.)). As a specific example, the operations of method 1200 may be performed by controller 860 to control one or more of light fixtures 802, 803, 811, 814, 815, and/or 820. In various embodiments, the operations of method 1200 may be performed in conjunction with any of the methods described herein, such as method 400, 410, 420, 430, 500, and/or 600.

In block 1202, the processor may receive an indication of a vehicle vending machine state. For example, an indication of a vehicle vending machine state may be an indication a vehicle is being lifted on the lift-able shuttle 112, an indication a vehicle is being rotated on the lift-able shuttle 112, an indication a vehicle is being lowered on the lift-able shuttle 112, an indication a vehicle is being moved to a delivery bay, an indication a vehicle is in the vehicle preparation area 288, an indication a vehicle is moving into a loading area 273a, etc. In various embodiments, the indication of the vehicle vending machine state may be received in response to an indication a vehicle event is occurring, such as movement, storage, etc., from a control system of the vehicle vending machine, an employee input to a control panel, etc.

In block 1204, the processor may determine a lighting sequence associated with the vehicle vending machine state. For example, lighting sequences may be stored in a memory correlated with vehicle vending machine states. A lighting sequence (or program) may be a set of control instructions for one or more light fixtures of the vehicle vending machine (e.g., 100, 200, etc.), such as instructions for the one or more of light fixtures 802, 803, 811, 814, 815, and/or 820. The lighting sequences may govern how the light fixtures (e.g., 802, 803, 811, 814, 815, and/or 820) illuminate, move, change, etc. Different lighting sequences may include different on/off times, different positions (e.g., tilts, pans, rotations, etc.), different illuminations (e.g., colors, diming levels, brightness levels, beam focuses, etc.), and/or any other different controllable elements for any one or more of the light fixtures (e.g., 802, 803, 811, 814, 815, and/or 820) in the vehicle vending machine (e.g., 100, 200, etc.). The processor may match a determined vehicle vending machine state to a vehicle vending machine state in memory. The lighting sequence correlated to that matching vehicle vending machine state may be determined to be the lighting sequence associated with the vehicle vending machine state.

In block 1206, the processor may control one or more light fixtures (e.g., 802, 803, 811, 814, 815, and/or 820) according to the determined lighting sequence. For example, the processor may turn on/off, change positions (e.g., tilts, pans, rotations, etc.), change illuminations (e.g., colors, diming levels, brightness levels, beam focuses, etc.), and/or change any other different controllable element for any one or more of the light fixtures (e.g., 802, 803, 811, 814, 815, and/or 820) according to the determined lighting sequence. In this manner, the customer experience may be improved by the lighting sequence associated with the determined vehicle vending machine state being implemented in the vehicle vending machine (e.g., 100, 200, etc.).

As described above, a fire originating at the top tier of the vehicle storage tower typically may not pose the hazard of vertical spread like a fire originating at a lower tier would. Similarly, because of typical concrete building construction, a fire originating in a typical parking garage is not susceptible to vertical fire spread. Therefore, in various embodiments, a vehicle at the top tier of a vehicle storage power may be protected with a set of sprinklers directly above them, and an additional set of sprinklers located directly above the vehicle lift area to fully protect the entire area covered by the roof assembly.

Since a fire originating at levels of the tower other than the highest tier has the potential to spread vertically, each vehicle at a level other than the highest tier may be protected with a set of “in-rack” sprinklers above each car and below the metal pallet of the vehicle above.

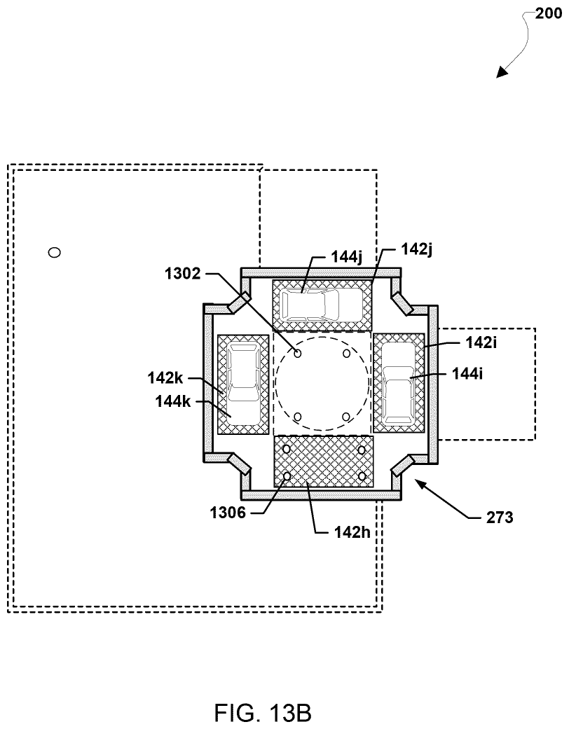

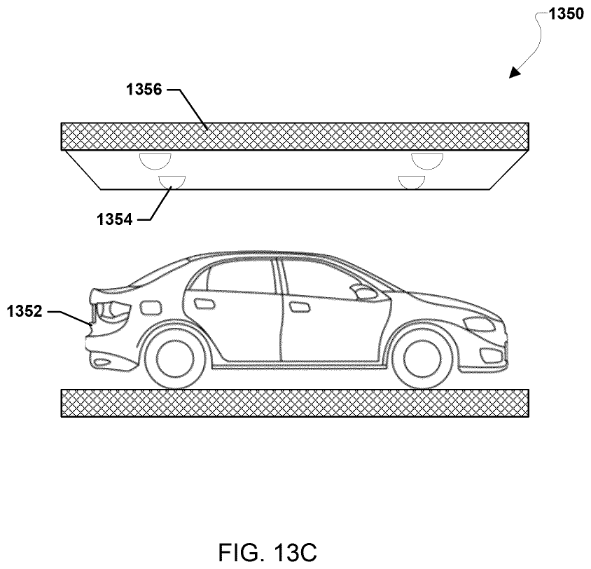

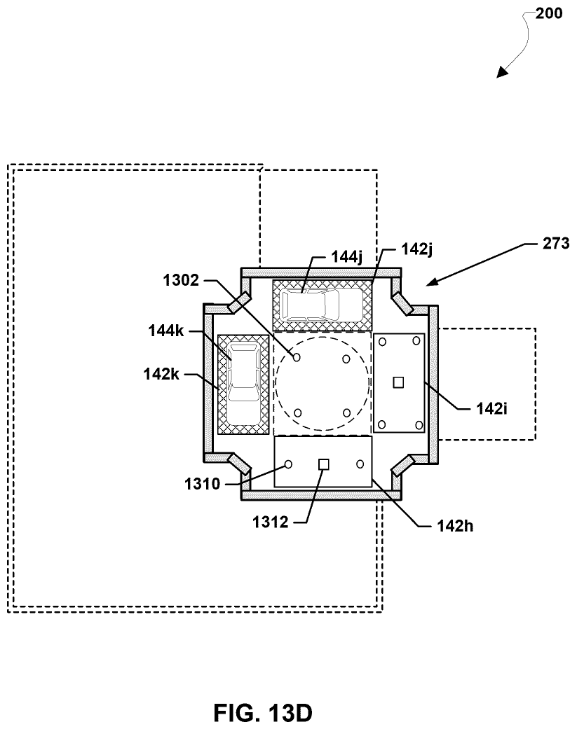

FIGS. 13A-13C are component block diagrams illustrating fire protection features for a tower of vehicle vending machine 200. With reference to FIGS. 1A-13C, the fire protection features illustrated in, and described with reference to, FIGS. 1A-13C are merely examples according to various embodiments. Additional or less features, alternative placements, and/or alternative arrangements on levels of the vehicle vending machine 200 may be substituted for the examples in FIGS. 13A-13C in various embodiments. In various embodiments, different levels of the vehicle vending machine 200 may include different features, such as the upper and lower floors including different fire sprinkler configurations than intermediate levels of the tower, different intermediate levels having different sprinkler configurations, an upper roof of the vehicle vending machine 200 having a different sprinkler configuration, etc.

FIG. 13A illustrates an example cut-away view inside the tower of the vehicle vending machine 200 showing four example sprinklers 1302 installed for the upper inside roof in the vehicle vending machine 200, and four overhead sprinklers 1304 above each of vehicle storage locations 1304 and 1306, corresponding to pallets 142h and 142i. Overhead sprinklers 1308 in the various embodiments may also be provided above each of the vehicle storage locations occupied by pallets 142j, 142k and vehicles 144j, 144k, respectively (not shown). While the overhead sprinklers 1308 are shown in sets of four, such number is provided as merely an example and is not intended to limit the various embodiments. In some embodiments, the overhead sprinklers provided for each vehicle storage location on an intermediate floor may be higher or lower than four.

In various embodiments, each intermediate floor of the tower (i.e., on a different vertical level than the ground floor and below the top floor) may include four in-rack sprinklers to protect each vehicle storage location. In particular, such in-rack sprinklers for each vehicle storage location may be housed on the bottom of the pallet for the vehicle storage location directly above. FIG. 13C illustrates an example cross-sectional view of an intermediate floor 1350 inside the tower of the vehicle vending machine 200, which includes in-rack sprinklers 1354 for a vehicle 1352. In various embodiments, the in-rack sprinklers 1354 may be spaced throughout the floor of pallet 1356. While the in-rack sprinklers 1354 are shown as a set of four, such number is provided as merely one example and is not intended to limit the various embodiments. In some embodiments, the in-rack sprinklers provided for each vehicle storage location on an intermediate floor may be higher or lower than four.

Each vehicle stored in an intermediate floor of the tower according to various embodiments may be protected by four in-rack or overhead sprinklers discharging 30 gallons per minute (gpm).

FIG. 13D is a component block diagram illustrating fire protection features for a tower of a vehicle vending machine 200. With reference to FIGS. 1A-13D, the fire protection features illustrated in, and described with reference to, FIGS. 1A-13D are merely examples according to various embodiments. Additional or less features (e.g., sprinklers, smoke detectors, flame detectors, heat sensors, gas detectors, air sampling systems, etc.), alternative placements, and/or alternative arrangements on levels of the vehicle vending machine 200 may be substituted for the example in FIG. 13D in various embodiments. In various embodiments, different levels of the vehicle vending machine 200 may include different features, such as the upper and lower floors including different fire sprinkler configurations than intermediate levels of the tower, different middle levels having different sprinkler configurations, an upper roof of the vehicle vending machine 200 having a different sprinkler configuration, etc.

FIG. 13D illustrates an example cut-away view inside the tower of the vehicle vending machine 200 showing four example sprinklers 1302 installed for the upper inside roof in the vehicle vending machine 200, and sprinklers 1310 above each of vehicle storage locations 1304 and 1306, corresponding to pallets 142h and 142i. Sprinklers 1310 in the various embodiments may also be provided above each of the vehicle storage locations occupied by pallets 142j, 142k and vehicles 144j, 144k, respectively (not shown in all respective locations in FIG. 13D for ease of illustration). That is, the sprinklers 1310 may be overhead sprinklers on the top level of the tower, and may be in-rack sprinklers on the intermediate floors of the tower. While the sprinklers 1310 are shown in sets of two, such number is provided as merely an example and is not intended to limit the various embodiments. In some embodiments, the overhead sprinklers provided for each vehicle storage location on an intermediate floor may be higher or lower than two.

In various embodiments, each vehicle storage location, whether on the top floor or an intermediate floor of the tower, may be protected by two sprinklers 1310 along the centerline above the vehicle, as well as one fire condition detector 1312, such as a smoke detector, flame detector, heat sensor, gas detector, air sampling system, or any other type detector configured to detect a condition associated with a fire, in between the two sprinklers. As one example, the fire condition detector 1312 may be an addressable smoke detector. As another example, the fire condition detector 1312 may be an air sampling system configured to monitor the air within the vehicle vending machine to determine whether particulate within the air is associated with a fire, such as a smoke particulate being above a threshold parts per million (PPM) in the air of the vehicle vending machine. While the fire condition detector 1312 are shown as one-per-vehicle storage location, such number is provided as merely an example and is not intended to limit the various embodiments. In some embodiments, the fire condition detector 1312 provided for each vehicle storage location on an intermediate floor may be higher or lower than one.

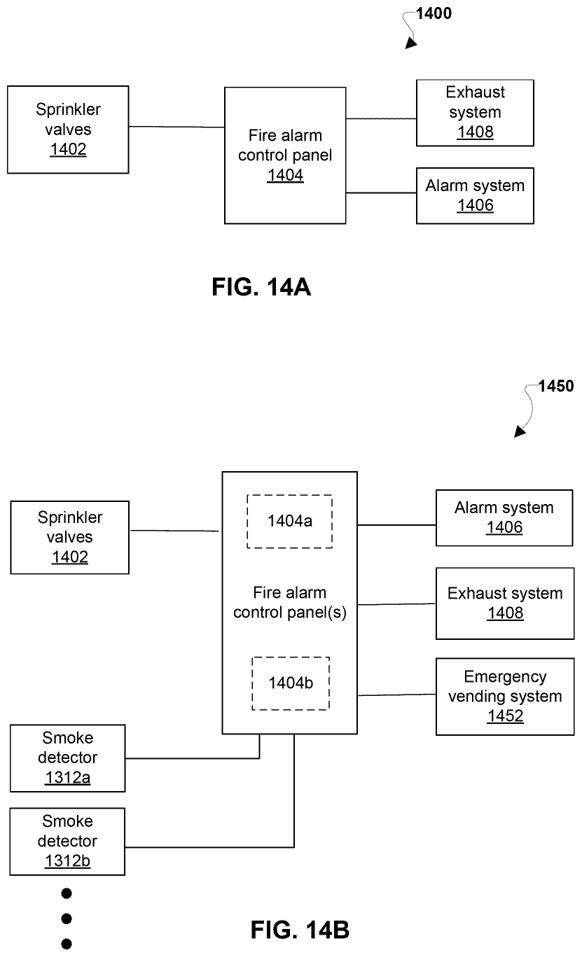

FIGS. 14A and 14B are component block diagrams illustrating connections and control operations between example fire protection features for a tower of vehicle vending machine 200. With reference to FIGS. 1A-14B, the fire protection features illustrated in, and described with reference to, FIGS. 1A-14B are merely examples according to various embodiments.

As shown in FIG. 14A, in an example vehicle vending machine (e.g., 200 in FIGS. 13A-13C), the tower may be configured with a number of heat-sensitive fire sprinklers (e.g., 1302, 1304, 1306) in various arrangements. In system 1400, sprinkler valves 1402 may correspond to any combination of sprinklers 1302, 1304, 1306. The sprinkler valves 1402, may be electronically supervised by a fire alarm control panel 1404. In various embodiments, in response to detecting water flow from one or more of the sprinkler valves 1402, the fire alarm control panel 1404 may activate an audible system 1406. In some embodiments, the alarm system 1406 may include an exterior audible alarm, as well as an alarm signal that is sent to an approved supervising station with which the fire alarm control panel 1404 is in communication. Further, in response to detecting water flow from one or more of the sprinkler valves 1402 fire alarm control panel 1404 may activate an exhaust system 1408. In various embodiments, the exhaust system 1408 may include one or multiple exhaust fans (e.g., two exhaust fans) that serve to keep the tower cool in warmer temperature. Such exhaust fans may be located on the roof of the tower, and directly discharge air into the atmosphere. Operation of each exhaust fan may be initiated in response to a thermostat, a carbon monoxide sensor, water flow from the sprinkler system, etc.

In the event that the fire alarm control panel 1404 detects a fire (e.g., based on detecting water flow from one or more sprinkler valve 1402), the exhaust fan(s) may be ramped up higher than normal operation to provide a large amount of exhaust. Further, activating the exhaust system 1408 may include automatically opening the exterior doors (e.g., 281a, 281b) of the delivery bays (e.g., 272a, 272b) in the tower 273.

As shown in FIG. 14B, in another example vending machine (e.g., vehicle vending machine 200 in FIG. 13D), the tower may be configured with a number of heat-sensitive fire sprinklers (e.g., 1302, 1310) and fire condition detectors 1312 (e.g., smoke detectors, gas detectors, air sampling systems, heat sensors, etc.) in various arrangements. In system 1450, the sprinkler valves 1402 may correspond to any combination of sprinklers 1302, 1310. The sprinkler valves 1402 may be electronically supervised by a fire alarm control panel 1404. In some embodiments, control functions for the fire protection system components may be performed by multiple distinct fire alarm control panels, or as different modules implemented by a shared control panel (i.e., on the same computing device). For example, the system 1450 may include a single fire alarm control panel that includes a first module 1404a configured to control operations of a first set of features, and a second module 1404b configured to control operations of a second set of features.

In various embodiments, in response to detecting water flow from one or more of the sprinkler valves 1402, fire alarm control panel(s) 1404 may activate an alarm system 1406. In various embodiments, the alarm system 1406 may include an exterior audible alarm as well as an alarm signal that may be sent to an approved supervising station with which it is in communication. In system 1450, fire condition detectors 1312 (e.g., smoke detectors, gas detectors, air sampling systems, heat sensors, etc.) may be located directly above each vehicle in the tower 273 (e.g., equidistant between two fire sprinklers 1310 along a centerline of the vehicle), as illustrated in FIG. 13B. In some embodiments, the fire condition detectors 1312 may be smoke detectors, such as Very Intelligent Early Warning (VIEW) detectors, which are 100 times more sensitive than a standard smoke detector and can achieve sensitivity levels from 0.02 percent-per-foot to 2 percent-per-foot obscuration. In various embodiments, the sensitivity of the fire condition detectors 1312 (e.g., smoke detectors, gas detectors, air sampling systems, heat sensors, etc.) may be calibrated to minimize any potential false alarms due to exhaust from vehicles that are driven on or off the lift-able shuttle 112 as compared to the more substantial amount of particulate in air generated by a fire. As one example, the sensitivity of the air sampling system may set such that the amount of smoke particulate in the air of the vehicle vending machine representing a threshold level for a fire is high enough that smoke particulates from vehicle exhaust do not trigger a false alarm.

In some embodiments, the fire condition detectors 1312 (e.g., smoke detectors, gas detectors, air sampling systems, heat sensors, etc.) may be each be connected (via wired or wireless connections) to fire alarm control panel(s) 1404, such as a Notifier's NFS-320 Intelligent Fire Alarm Control Panel. As one example, the fire condition detectors 1312 may be addressable smoke detectors each connected (via wired or wireless connections) to fire alarm control panel(s) 1404, such as a Notifier's NFS-320 Intelligent Fire Alarm Control Panel. Upon detecting that a fire condition detector 1312, such as a smoke detector, etc., has been triggered, the fire alarm control panel(s) 1404 may activate an emergency vending system 1452 with respect to a vehicle stored in the space associated with the triggered detector (i.e., vehicle of fire origin) In particular, activation of the emergency vending system 1452 may prompt retrieval of the vehicle of fire origin from its storage location, and placement of the vehicle on its pallet onto the lift-able shuttle 112. In various embodiments, the lift-able shuttle may lower the vehicle of fire origin and pallet to the ground level, and the vehicle may be delivered to an appropriate delivery bay based on conditions. For example, the vehicle of fire origin may be brought to delivery bay 272a or 272b. In this manner, the vehicle of fire origin may be removed from storage and moved to the ground level to be furthest from other vehicles and to give firefighters the easiest access to the fire, reducing the possibility of flame spread.

In various embodiments, the emergency vending system 1452 may be programmed to automatically deliver the vehicle of fire origin to a first delivery bay (e.g., 272a) as a default, and to switch to a second delivery bay (e.g., 272b) if the first is already occupied by another vehicle. In various embodiments, the operations of the emergency vending system 1452 may include sending a signal to open the exterior doors of the delivery bay to which the vehicle of fire origin is delivered.

Further, in response to detecting a fire (e.g., based on detecting water flow from one or more of the sprinkler valves 1402 and/or detecting activation of one or more fire condition detector 1312, such as one or more smoke detector, one or more heat sensor, one or more gas detector, one or more air sampling systems, etc.), fire alarm control panel(s) 1404 may activate the exhaust system 1408. Activating the exhaust system 1410 may include automatically opening the exterior doors (e.g., 281a, 281b) of the delivery bays (e.g., 272a, 272b) in the tower 273.

In some embodiments, if the lift-able shuttle has a vehicle already loaded when the emergency vending system is activated, the controller may send a signal to the emergency vending system to place that vehicle in a spare space before retrieving the vehicle of fire origin. In various embodiments, the spare space may be a vehicle location in the tower that is one level above the group level and is kept empty in case of emergency vending operation.

In some embodiments, the controller may wait to receive a signal indicating that the tower is secure (i.e., no persons in the tower) verified by the locking of a tower access door before activating the emergency vending system. If the lift-able shuttle is in use when the emergency vending system is activated, the controller may wait to receive a signal indicating that the lift-able shuttle is available before activating the emergency vending system.

In some embodiments, the processes of the emergency vending system 1452 include many of the same steps discussed above with respect to FIGS. 6A-6D. For example, the detected vehicle that is the origin of the fire may be retrieved on its vehicle pallet from the storage location, placed on the robotic carrier, and navigated to a delivery bay, such as a delivery bay with sprinklers therein. In this manner, a burning vehicle may be moved out of the tower and into a delivery bay. As a specific example, the lift-able shuttle may raise to an appropriate level of the tower where the vehicle that is the fire origin is located, retrieve the vehicle on its vehicle pallet onto the lift-able shuttle, the lift-able shuttle may be lowered with the vehicle that is the fire origin thereon, the vehicle that is the fire origin may be rotated as needed, and the vehicle that is the fire origin positioned on the vehicle pallet may be placed on the robotic carrier, and the robotic carrier may move the vehicle that is the fire origin positioned on the vehicle pallet to a delivery bay. In this manner, the lift-able shuttle and robotic carrier may be used to vend a burning vehicle from the tower to a delivery bay such that the burning vehicle is less risk to the other vehicles in the tower and tower itself and/or firefighters may have easier access to the burning vehicle in the delivery bay than would be had if the burning vehicle was located in the tower. In various embodiments, the processes of the emergency vending system 1452 may be fully automatic, but firefighter manual controls may also be provided at one or more delivery bay (e.g., 272a, 272b).

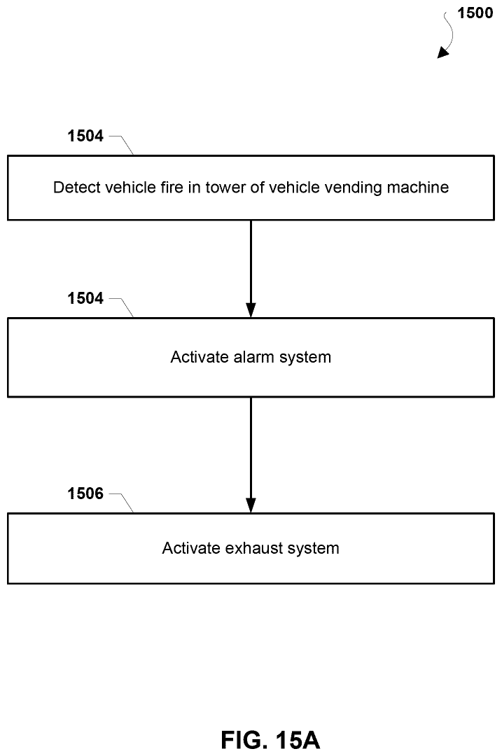

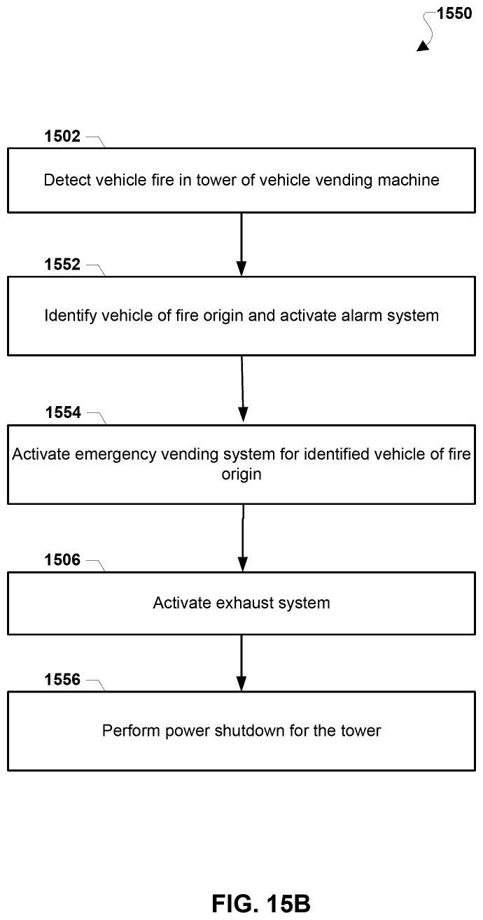

FIG. 15A illustrates a method 1500 for controlling a fire protection system for a vehicle vending machine according to various embodiments. With reference to FIGS. 1A-15A, the operations of the method 1500 may be performed by one or more processors of a vehicle vending machine (e.g., vehicle vending machine (e.g., vending machine 100, 200, etc.)). In a particular example, the operations of method 1500 may be performed by a controller of the fire alarm control panel(s) 1404.

In various embodiments, the operations of method 1500 may be performed in conjunction with any of the methods described herein, such as method 400, 410, 420, 430, 500, and/or 600.

In block 1502, the controller may detect a vehicle fire in a storage tower of the vehicle vending machine. In some embodiments, detection of the vehicle fire may be the result of detecting activation of one or more fire sprinklers positioned within the tower, for example, water flow from one or more sprinkler valve (e.g., 1402).

In block 1504, the controller may activate an alarm system. In some embodiments, activating the alarm system may involve activating an audible alarm exterior to the tower within the vehicle vending machine, and automatically sending an alarm signal to a supervising station to deploy firefighters.

In block 1506, the controller may activate an exhaust system. In various embodiments, the exhaust system (e.g., 1408) may include two fans that are capable of operating simultaneously for a total exhaust volumetric flow rate of 16,500 cubic feet per minute (CFM) (i.e., 5.6 air changes per hour). FIG. 15B illustrates another method 1550 for controlling a fire protection system for a vehicle vending machine according to various embodiments. With reference to FIGS. 1A-15B, the operations of the method 1550 may be performed by one or more processor of a vehicle vending machine (e.g., vending machine 100, 200, etc.). n a particular example, the operations of method 1550 may be performed by a controller of the fire alarm control panel(s) 1404.

In various embodiments, the operations of method 1550 may be performed in conjunction with any of the methods described herein, such as method 400, 410, 420, 430, 500, 600, 1500.

In block 1502, the controller may detect a vehicle fire in a storage tower of the vehicle vending machine. In some embodiments, detection of the vehicle fire may be the result of detecting activation of one or more fire sprinklers positioned within the tower, for example, water flow from one or more sprinkler valve (e.g., 1402). In some embodiments, detection of the vehicle fire may additionally or alternatively be the result of detecting activation of one or more fire condition detector (e.g., 1312), such as a smoke detector, etc., positioned within the tower.

In block 1552, the controller may identify the vehicle of fire origin and activate an alarm system. In some embodiments, identifying the vehicle of fire origin may be based on the location of a fire condition detector (e.g., 1312), such as a smoke detector, etc., that has been activated and/or fire sprinkler (e.g., overhead sprinkler(s) 1304, in-rack sprinkler(s) 1306) with valves that have been triggered to spray water. In some embodiments, alarm system activation may be automatically performed based on input to the controller from the activated fire condition detector (e.g., 1312), such as an activated smoke detector, etc., and/or from one or more activated fire sprinkler. In some embodiments, activating the alarm system may involve activating an audible alarm exterior to the tower within the vehicle vending machine, and automatically sending an alarm signal to a supervising station to deploy firefighters.

In block 1554, the controller may activate an emergency vending system for the vehicle of fire origin. In some embodiments, activating the emergency vending system for the vehicle of fire origin may include triggering a controller to retrieve the identified vehicle of fire origin positioned on a vehicle pallet from a storage location within the tower. In some embodiments, retrieving the identified vehicle of fire origin positioned on the vehicle pallet may be performed with a lift-able shuttle. Various embodiments may further include delivering the vehicle of fire origin positioned on the vehicle pallet to an appropriate delivery bay of the vehicle vending machine. In various embodiments, the activation of the emergency vending system for the vehicle of fire origin may result in vending of the vehicle of fire origin from that vehicle's location in the tower to a delivery bay by one or more of the operations for methods for operating a vehicle vending machine discussed above with respect to FIGS. 6A-6D. For example, the activation of the emergency vending system for the vehicle of fire origin may result in the lift-able shuttle and robotic carrier being controlled individually and/or in concert to vend the vehicle of fire origin from the tower to a delivery bay such that the vehicle of fire origin is less risk to the other vehicles in the tower and tower itself. As further example, the activation of the emergency vending system for the vehicle of fire origin may result in the lift-able shuttle and robotic carrier being controlled individually and/or in concert to vend the vehicle of fire origin from the tower to a delivery bay such that firefighters may have easier access to the burning vehicle in the delivery bay than would be had if the burning vehicle was located in the tower.

In block 1506, the controller may activate an exhaust system, in the same manner as described with respect to method 1500.

In block 1556, the controller may perform a power shutdown of the tower. In some embodiments, such power shutdown may include power for all electronic and other systems of the tower (e.g., the ADS, the lift-able shuttle, etc.) except for the exhaust system and emergency lighting. In one embodiment, the power shutdown may be performed only after receipt of a signal from the emergency vending system indicating that the vehicle of fire origin has been delivered to a delivery bay. In another embodiment, the power shutdown may be automatically initiated, with standby power provided for any critical components required for operation of the emergency vending system.

In some embodiments, the tower may be additionally configured with a means for emergency personnel (e.g., firefighters and first responders) to manually shutdown the operations.

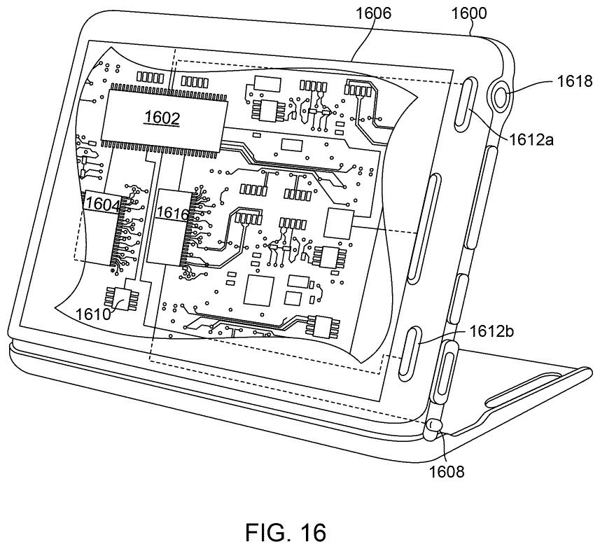

The various embodiments may be implemented in any of a variety of computing devices, an example of which is illustrated in FIG. 16. For example, a computing device may be a mobile device 1600 which may include a processor 1602 coupled to internal memories 1604 and 1610. Internal memories 1604 and 1610 may be volatile or non-volatile memories, and may also be secure and/or encrypted memories, or unsecure and/or unencrypted memories, or any combination thereof. The processor 1602 may also be coupled to a touch screen display 1606, such as a resistive-sensing touch screen, capacitive-sensing touch screen infrared sensing touch screen, or the like. Additionally, the display of the mobile device 1600 need not have touch screen capability. Additionally, the mobile device 1600 may have one or more antenna 1608 for sending and receiving electromagnetic radiation that may be connected to network interface, such as a wireless data link and/or cellular telephone transceiver 1616, coupled to the processor 1602. The mobile device 1600 may also include physical buttons 1612a and 1612b for receiving user inputs. The mobile device 1600 may also include a power button 1618 for turning the mobile device 1600 on and off.

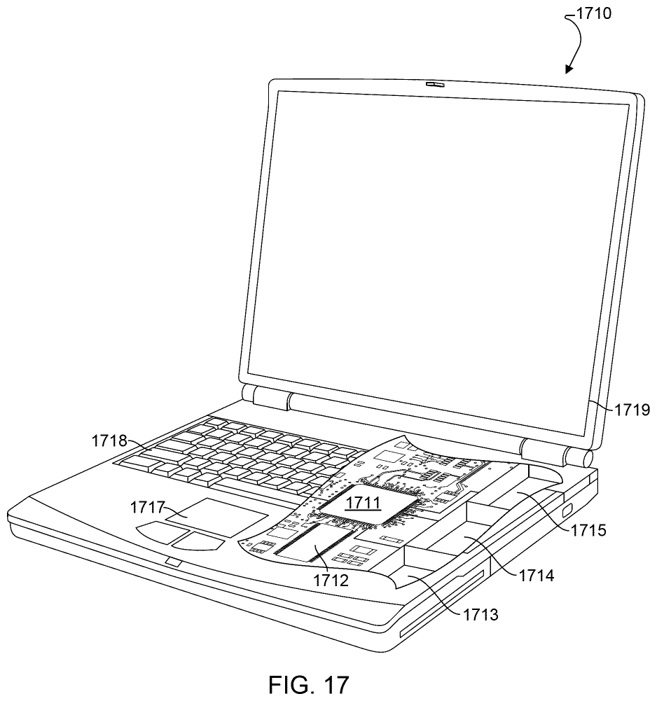

The various embodiments described above may also be implemented within a variety of computing devices, such as a laptop computer 1710 as illustrated in FIG. 17. Many laptop computers include a touchpad touch surface 1717 that serves as the computer's pointing device, and thus may receive drag, scroll, and flick gestures similar to those implemented on mobile computing devices equipped with a touch screen display and described above. A laptop computer 1710 will typically include a processor 1711 coupled to volatile memory 1712 and a large capacity nonvolatile memory, such as a disk drive 1713 of Flash memory. The laptop computer 1710 may also include a floppy disc drive 1714 and a compact disc (CD) drive 1715 coupled to the processor 1711. The laptop computer 1710 may also include a number of connector ports coupled to the processor 1711 for establishing data connections or receiving external memory devices, such as a USB or FireWire® connector sockets, or other network connection circuits (e.g., interfaces) for coupling the processor 1711 to a network. In a notebook configuration, the computer housing may include the touchpad 1717, the keyboard 1718, and the display 1719 all coupled to the processor 1711. Other configurations of the computing device may include a computer mouse or trackball coupled to the processor (e.g., via a USB input) as are well known, which may also be used in conjunction with the various embodiments.

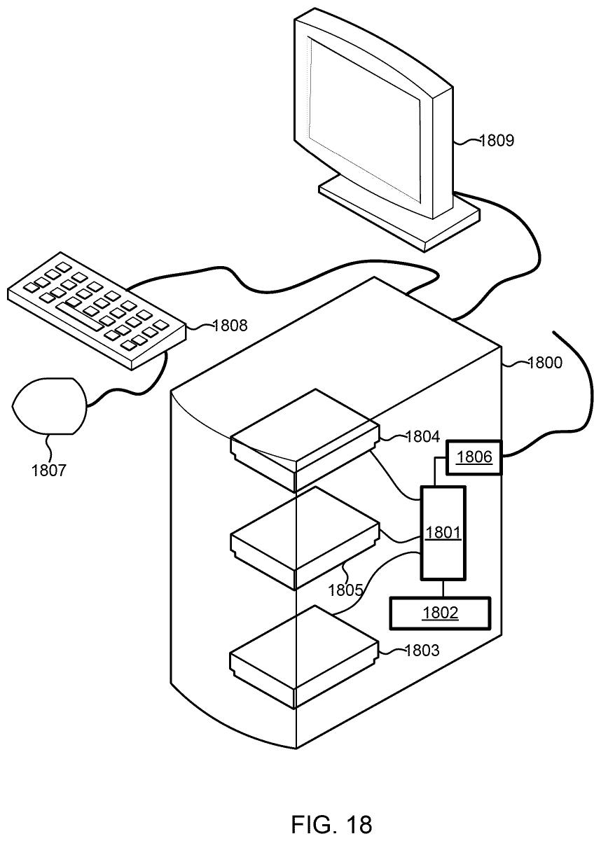

The various embodiments described above may also be implemented within a variety of computing devices, such as a terminal computer 1800 as illustrated in FIG. 18. A terminal computer 1800 will typically include a processor 1801 coupled to volatile memory 1802 and a large capacity nonvolatile memory, such as a disk drive 1804 of Flash memory. The terminal 1800 may also include a floppy disc drive 1805 and a compact disc (CD) drive 1803 coupled to the processor 1801. The terminal 1800 may also include a number of connector ports 1806 coupled to the processor 1801 for establishing data connections or receiving external memory devices, such as a USB or FireWire® connector sockets, or other network connection circuits (e.g., interfaces) for coupling the processor 1811 to a network. Additionally, a keyboard 1808, mouse 1807, and display 1819 may all be coupled to the processor 1801.

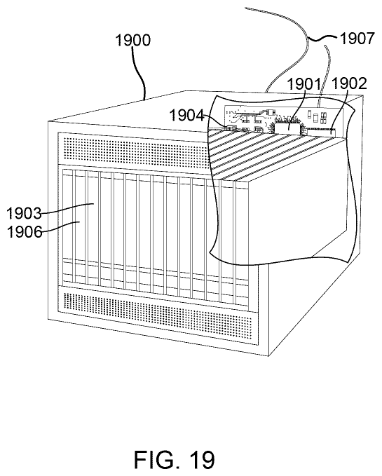

The various embodiments may also be implemented on any of a variety of commercially available server devices, such as the server 1900 illustrated in FIG. 19. Such a server 1900 typically includes a processor 1901 coupled to volatile memory 1902 and a large capacity nonvolatile memory, such as a disk drive 1903. The server 1900 may also include a floppy disc drive, compact disc (CD) or DVD disc drive 1906 coupled to the processor 1901. The server 1900 may also include network access ports 1904 (network interfaces) coupled to the processor 1901 for establishing network interface connections with a network 1907, such as a local area network coupled to other computers and servers, the Internet, the public switched telephone network, and/or a cellular data network (e.g., CDMA, TDMA, GSM, PCS, 3G, 4G, LTE, or any other type of cellular data network).

The processors 1602, 1711, 1801, and 1901 may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory before they are accessed and loaded into the processors 1602, 1711, 1801, and 1901. The processors 1602, 1711, 1801, and 1901 may include internal memory sufficient to store the application software instructions. In many devices the internal memory may be a volatile or nonvolatile memory, such as flash memory, or a mixture of both. For the purposes of this description, a general reference to memory refers to memory accessible by the processors 1602, 1711, 1801, and 1901 including internal memory or removable memory plugged into the device and memory within the processor 1602, 1711, 1801, and 1901 themselves.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more processor-executable instructions or code on a non-transitory computer-readable medium, non-transitory processor-readable medium, or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A vehicle vending machine, comprising:
at least one first delivery bay;
a tower comprising a series of storage locations on different vertically arranged levels, wherein at least a portion of the series of storage locations are on at least one of the different vertically arranged levels of the tower that is vertically offset from the first delivery bay; and
a system configured to retrieve a customer vehicle from a storage location in the tower and deliver the customer vehicle to the first delivery bay.

2. The vehicle vending machine of claim 1, further comprising:
a fire protection system, comprising:
a plurality of fire sprinklers; and
one or more controller connected to the plurality of fire sprinklers, wherein the one or more controller is configured to trigger activation of at least an alarm system and an exhaust system.

3. The vehicle vending machine of claim 2, wherein the plurality of fire sprinklers each comprises a thermosensitive sprinkler head and a valve, wherein water automatically flows from the valve upon reaching a threshold temperature in surrounding air.

4. The vehicle vending machine of claim 2, wherein the alarm system comprises an audible external alarm and an alarm signal that is sent to a supervising station.

5. The vehicle vending machine of claim 2, wherein the exhaust system comprises a plurality of exhaust fans.

6. The vehicle vending machine of claim 2, wherein the fire protection system further comprises:
a plurality of fire condition detectors connected to the one or more controller; and
an emergency vending system connected to the one or more controller, wherein the one or more controller is configured to activate the emergency vending system in response to detecting a fire.

7. The vehicle vending machine of claim 6, wherein:
detecting a fire comprises identifying a storage location of a vehicle of fire origin based on input from at least one of the plurality of fire condition detectors; and
activation of the emergency vending system comprises triggering delivery of the vehicle of fire origin positioned on a vehicle pallet from the identified storage location in the tower to the first delivery bay.

8. The vehicle vending machine of claim 6, wherein the plurality of fire condition detectors comprise one or more of a smoke detector, a flame detector, a heat sensor, a gas detector, air sampling system, or any other type detector configured to detect a condition associated with a fire.

9. The vehicle vending machine of claim 6, wherein the plurality of fire condition detectors comprise a plurality of addressable smoke detectors.

10. The vehicle vending machine of claim 6, wherein the plurality of fire condition detectors comprise at least one air sampling system configured to determine a level of particulate associated with a fire in the air of the vehicle vending machine.

11. A method for operating a vehicle vending machine with a fire protection system, comprising:
detecting a vehicle fire in a storage tower of the vehicle vending machine;
in response to detecting the vehicle fire in the storage tower:
activating an alarm system; and
activating an exhaust system.

12. The method of claim 11, wherein detecting the vehicle fire in the storage tower of the vehicle vending machine comprises:
detecting activation of one or more fire sprinklers positioned within the storage tower.

13. The method of claim 11, wherein activating the alarm system comprises:
activating an audible alarm exterior to the storage tower within the vehicle vending machine; and
automatically sending an alarm signal to a supervising station.

14. The method of claim 11, wherein the exhaust system includes a plurality of fans that are capable of operating simultaneously for a total exhaust volumetric flow rate of at least 16,500 cubic feet per minute (CFM).

15. The method of claim 11, wherein detecting the vehicle fire in the storage tower of the vehicle vending machine comprises detecting activation of at least one of:
a fire sprinkler positioned within the storage tower; and
a fire condition detector positioned within the storage tower.

16. The method of claim 11, further comprising:
identifying a vehicle of fire origin based on a location of at least one of an activated fire condition detector or an activated fire sprinkler located within the storage tower.

17. The method of claim 15, wherein the fire condition detector comprises one or more of a smoke detector, a flame detector, a heat sensor, a gas detector, air sampling system, or any other type of detector configured to detect a condition associated with a fire.

18. The method of claim 15, wherein the fire condition detector comprises at least one addressable smoke detector.

19. The method of claim 15, wherein the fire condition detector comprises at least one air sampling system configured to determine a level of particulate associated with a fire in the air of the vehicle vending machine.

20. The method of claim 16, further comprising:
activating an emergency vending system for the vehicle of fire origin; and
performing a power shutdown of electronic systems of the storage tower.

21. The method of claim 20, wherein activating the emergency vending system for the vehicle of fire origin comprises:
triggering a controller to retrieve the identified vehicle of fire origin positioned on a vehicle pallet from a storage location within the storage tower, wherein the retrieving is performed with a lift-able shuttle; and
delivering the vehicle of fire origin positioned on the vehicle pallet to an appropriate delivery bay of the vehicle vending machine.

22. The method of claim 21, wherein retrieving the identified vehicle of fire origin positioned on the vehicle pallet from the storage location within the storage tower comprises:
rotating the vehicle pallet from a rotated appropriate orientation; and
positioning the vehicle of fire origin positioned on the vehicle pallet onto a robotic carrier.

23. The method of claim 21, wherein activating the exhaust system comprises:
receiving a notification that the vehicle of fire origin positioned on the vehicle pallet has been delivered to the appropriate delivery bay; and
automatically opening at least one exterior door of the appropriate delivery bay in response to receiving the notification.

24. The method of claim 21, wherein the storage location is vertically offset from a plurality of delivery bays.
